(19) United States
(12) Patent Application Publication
(10) Pub. No.: US 2016/0342757 A1
(43) Pub. Date: Nov. 24, 2016

(54) DIAGNOSING AND MONITORING DEPRESSION DISORDERS

(71) Applicant: Vindrauga Holdings, LLC, San Diego, CA (US)

(72) Inventors: John Bilello, Durham, NC (US); Yiwu He, Mercer Island, WA (US); Bo Pi, Carlsbad, CA (US)

(73) Assignee: Vindrauga Holdings, LLC, San Diego, CA (US)

(21) Appl. No.: 15/230,154

(22) Filed: Aug. 5, 2016

Related U.S. Application Data
(63) Continuation of application No. 14/154,989, filed on Jan. 14, 2014, now abandoned.
Application No. 14/154,989 is a continuation-in-part of application No. 12/921,349, filed on Apr. 27, 2011, now abandoned.
Application No. 14/154,989 is a continuation-in-part of application No. 12/922,365, filed on May 12, 2011, now abandoned.
Application No. 14/154,989 is a continuation-in-part of application No. 12/579,733, filed on Oct. 15, 2009, now abandoned.
Application No. 14/154,989 is a continuation-in-part of application No. 13/892,714, filed on May 13, 2013, now abandoned.
Application No. 13/892,714 is a continuation of application No. 12/620,831, filed on Nov. 18, 2009, now Pat. No. 8,440,418.
(60) Provisional application No. 61/033,726, filed on Mar. 4, 2008.
(60) Provisional application No. 61/033,721, filed on Mar. 4, 2008.
(60) Provisional application No. 61/033,731, filed on Mar. 4, 2008.
(60) Provisional application No. 61/036,013, filed on Mar. 12, 2008.
(60) Provisional application No. 61/105,641, filed on Oct. 15, 2008.
(60) Provisional application No. 61/115,710, filed on Nov. 18, 2008.

(51) Int. Cl. G06F 19/00

(52) U.S. Cl. CPC G06F 19/345; G06F 19/3431; G06F 19/3406; G06F 19/322

(57) ABSTRACT

Materials and methods related to developing a disease score for a depression disorder (e.g., unipolar depression or major depressive disorder) in a subject using a multi-parameter system to measure a plurality of parameters, and an algorithm to calculate the score. The materials and methods can be used to, for example, diagnose depression disorders, or determine a subject's predisposition to develop a depression disorder. The methods also can include using a multi-parameter hypermapping system and algorithms related thereto.

### CROSS-REFERENCE TO RELATED APPLICATIONS

This application is a continuation-in-part of U.S. patent application Ser. No. 12/921,349, filed on Apr. 27, 2011, which is a National Stage application under 35 U.S.C. §371 of international Application No. PCT/US2009/036084, having an international Filing Date of Mar. 4, 2009, which claims benefit of priority from U.S. Provisional Application Ser. Nos. 61/033,726, 61/033,721, and 61/033,731, all filed on Mar. 4, 2008.

This application also is a continuation-in-part of U.S. patent application Ser. No. 12/922,365, filed on May 12, 2011, which is a National Stage application under 35 U.S.C. §371 of International Application No. PCT/US2009/036833, filed on Mar. 11, 2009, which claims benefit of priority from U.S. Provisional Application Ser. No. 61/036,013, filed on Mar. 12, 2008.

In addition, this application is a continuation-in-part of U.S. patent application Ser. No. 12/579,733, filed on Oct. 15, 2009, which claims benefit of priority from U.S. Provisional Application Ser. No. 61/105,641, filed on Oct. 15, 2008.

Further, this application is continuation-in-part of U.S. patent application Ser. No. 13/892,714, filed on May 13, 2013, which is a continuation of U.S. patent application Ser. No. 12/620,831, filed on Nov. 18, 2009, which claims benefit of priority from U.S. Provisional Application Ser. No. 61/115,710, filed on Nov. 18, 2008.

### TECHNICAL FIELD

This document relates to biomarkers and methods for diagnosing, assessing, and monitoring treatment of medical conditions such as major depressive disorder (MDD). For example, this document relates to materials and methods for diagnosing or assessing a depression disorder in a subject, or determining a subject's predisposition to develop a depression disorder, or to respond to particular treatment modalities using algorithms and hypermapping based on a combination of parameters.

### BACKGROUND

People can live with neuropsychiatric conditions for extended lengths of time. In fact, neuropsychiatric conditions account for more “years lived with disability” (YLDs) than any other type of clinical condition, accounting for almost 30% of total YLDs (Murray and Lopez (1996) Global Health Statistics: A Compendium of Incidence, Prevalence and Mortality Estimates for over 2000 Conditions Cambridge: Harvard School of Public Health). Unipolar MDD alone accounts for 11% of global YLDs. A number of factors may contribute to sustained disability and less than optimal treatment outcomes, including inaccurate diagnosis, early discontinuation of treatment by clinicians, social stigma, inadequate antidepressant dosing, antidepressant side effects, and non-adherence to treatment by patients.

Biobehavioral research can be a challenging scientific endeavor, as biological organisms display wide-ranging individual differences in physiology. Most clinical disorders, including neuropsychiatric conditions such as depression disorders (e.g., major depressive disorder (MDD)), do not arise due to a single biological change, but rather result from interactions between multiple factors rather than from a single biological change. Thus, different individuals affected by the same clinical condition may present with different types, ranges, or extents of symptoms, depending on the specific changes within each individual. The ability to determine depression disease status on an individual basis would be useful for accurate assessment of a subject's specific status. There is a need, however, for reliable methods for diagnosing and determining predisposition to clinical conditions such as depression, and for assessing disease status or response to treatment on an individual basis.

### SUMMARY

The development of psychotropic drugs has relied on the quantification of disease severity through psychopathological parameters (e.g., the Hamilton scale for depression). Subjective factors and lack of a proper definition inevitably influence such parameters. Similarly, diagnostic parameters for enrollment of psychiatric patients in phase II and phase III clinical studies are centered on the assessment of disease severity and specificity by measurement of symptomatological scales, and there are no validated biological correlates for disease trait and state that can help in patient selection. In spite of recent progress in molecular diagnostics, the potential information contained within the patient genotype on the likely phenotypic response to drug treatment has not been effectively captured, particularly in non-research settings.

The immune system has a complex and dynamic relationship with the nervous system, both in health and disease. The immune system surveys the central and peripheral nervous systems, and can be activated in response to foreign proteins, infectious agents, stress, and neoplasia. Conversely, the nervous system modulates immune system function both through the neuroendocrine axis and through vagus nerve efferents. The hypothalamic-pituitary-adrenal (HPA) hyperactivity hypothesis states that when this dynamic relationship is perturbed, it results in neuropsychiatric disorders such as depression. HPA axis activity is governed by secretion of corticotropin-releasing hormone (CRH or CRF) from the hypothalamus. CRH activates secretion of adrenocorticotropic hormone (ACTH) from the pituitary, and ACTH, in turn, stimulates secretion of glucocorticoids (cortisol in humans) from the adrenal glands. Release of cortisol into the circulation has a number of effects, including elevation of blood glucose. If the negative feedback of cortisol to the hypothalamus, pituitary and immune system is impaired, the HPA axis can be continually activated, and excess cortisol is released. Cortisol receptors become desensitized, leading to increased activity of the pro-inflammatory immune mediators and disturbances in neurotransmitter transmission.

The ability to determine disease status on an individual basis thus would be useful for accurate assessment of a subject's specific status. There is a need, however, for reliable methods of diagnosing or determining predisposition to clinical conditions, and of assessing a subject's disease status or response to treatment.

This document relates to materials and methods for diagnosing and assessing treatment of depression disorders, including MDD. Clinical assessments and patient interviews are commonly used for diagnosing and monitoring treatment of patients with depression. As described herein, a test based on physiological changes (e.g., changes assessed by measuring biomarkers and, in some embodiments, deriving a disease score using a computational algorithm) will facilitate earlier treatment of depression and increase acceptance by patients. The techniques described herein can be configured to optimize therapy based on physiological measurements in place of or in addition to clinical assessments and patient interviews.

Certain preliminary studies indicated the value of using multiplexed antibody arrays to develop a panel of biomarkers in populations with MDD. The availability of biological markers reflecting psychiatric state (e.g., the type of pathology, severity, likelihood of positive response to treatment, and vulnerability to relapse) is likely to impact both the appropriate diagnosis and treatment of depression. The systematic, highly parallel, combinatorial approach to assemble “disease specific signatures” using algorithms as described herein can be used to determine the status of MDD, and also to predict an individual's response to therapy.

As used herein, a “biomarker” is a characteristic that can be objectively measured and evaluated as an indicator of a normal biologic or pathogenic process or pharmacological response to a therapeutic intervention. Biomarkers can provide independent diagnostic or prognostic value by reflecting an underlying condition or disease state. The use of biomarkers can allow for accuracy, reliability, sensitivity, specificity, and predictability for assessing disease status. For example, CRP (C-reactive protein) can be used as a plasma biomarker of low grade systemic inflammation, which can be linked to diverse disorders such as rheumatoid and osteoarthritis, allergies, asthma, Alzheimer's disease, cancer, diabetes, digestive disorders, heart disease, hormonal imbalances, and osteoporosis. While biological markers of inflammation may be useful in monitoring the severity of a specific disease, their clinical utility, particularly in the context of an individual marker, seems limited. It appears, however, that the pattern of inflammatory biomarker expression may differ in different disease syndromes, and the levels of multiple markers may be useful in assessing the severity of disease.

Traditional approaches to biomarkers often have included analyzing single markers or groups of single markers. Other approaches have included using algorithms to derive a single value that reflects disease status, prognosis, and/or response to treatment. The approach described herein differs from some of the more traditional approaches to application of biomarkers, in that a multiple analyte algorithm is used rather than a single marker or a group of single markers. Algorithms can be used to derive a single value that reflects disease status, prognosis, and/or response to treatment. As described herein, highly multiplexed microarray-based immunological tools can be used to simultaneously measure multiple parameters. An advantage of using such tools is that all results can be derived from the same sample and run under the same conditions at the same time. In addition to traditional multivariate and regression analysis, high-level pattern recognition approaches can be applied. A number of tools are available, including Ridge Diagnostics' proprietary BIOMARKER HYPER-MAPPING™ (BHM) technology, as well as clustering approaches such as hierarchical clustering, self-organizing maps, and supervised classification algorithms (e.g., support vector machines, k-nearest neighbors, hypermapping, and neural networks). Both BIOMARKER HYPER-MAPPING™ technology and supervised classification algorithms are likely to be of substantial clinical use.

Thus, this document is based in part on the identification of methods for determining diagnosis or prognosis of depressive disorders (e.g., unipolar depression and MDD), as well as methods for monitoring treatment and/or progression of such disorders. The methods can include developing an algorithm that includes multiple parameters such as biomarkers (e.g., inflammatory biomarkers, HPA axis biomarkers, metabolic biomarkers, and/or neuromodulatory biomarkers), measuring the multiple parameters, and using the algorithm to determine a quantitative diagnostic score. In some implementations, algorithms for application of multiple biomarkers from biological samples such as cells, serum, or plasma can be developed for patient stratification, identification of pharmacodynamic markers, and monitoring the efficacy and outcome of treatment.

A basic method can include providing a biological sample (e.g., a blood sample) from a depressed individual; measuring the levels of a group of analytes in the sample; and using an algorithm to determine a MDD disease score. In some embodiments, the method can further include repeating the test after a period of time (e.g., weeks or months); calculating a post-treatment MDD disease score; and comparing the post-treatment score to the earlier score, and also to a control MDD disease score (e.g., an average MDD score determined in normal subjects who do not have a depression disorder). Evidence of a change in a depressed individual's MDD disease score toward a normal value can indicate effectiveness of the therapy. Depending on the nature of the therapeutic regimen, such changes may be observable within the first two months of treatment (e.g., for psychotherapy), or in as little as seven days (e.g., for administration of antidepressant therapy).

This document also describes techniques for monitoring the effectiveness of therapy in a depressed individual at an early stage of psychotherapy, cognitive therapy, or antidepressant administration. The methods include determining whether there has been a change in the plasma biomarkers in an individual treated for depression. Materials and methods are described for developing a unipolar depression (MDD) disease score in a subject, using a multi-parameter system to measure a plurality of parameters and an algorithm to calculate a score. The score determined at two or more time points can be used to determine the progression of MDD or to assess a subject's response to a therapeutic regimen, for example.

The present document also is based in part on the identification of methods for using hypermapping to determine diagnosis, prognosis, or predisposition to depression disorder conditions, and also to determine response to therapy. In addition, this document is based on the identification of methods for using hypermapping to determine diagnosis, prognosis, or predisposition to conditions such as infectious or chronic diseases. The methods can include, for example, selecting groups of biomarkers that may be related to a particular condition, obtaining clinical data from subjects for the selected groups of biomarkers, applying an optimization algorithm to the clinical data in order to arrive at coefficients for selected biomarkers within each group, creating a hypermap by developing vectors for each group of biomarkers, and using the hypermap to generate a diagnosis or decision (e.g., related to treatment or disease status) for an individual who may or may not have the condition. In some embodiments, for example, algorithms and hypermaps incorporating data from multiple biomarkers in biological samples such as serum or plasma can be developed for patient stratification, identification of pharmacodynamic markers, and monitoring treatment outcome.

In one aspect, this document features a method for diagnosing depression in a human subject, comprising (a) providing numerical values for a plurality of parameters predetermined to be relevant to depression; (b) individually weighting each of the numerical values by a predetermined function, each function being specific to each parameter; (c) determining the sum of the weighted values; (d) determining the difference between the sum and a control value; and (e) if the difference is greater than a predetermined threshold, classifying the subject as having depression or, if the difference is not different than the predetermined threshold, classifying the subject as not having depression.

The parameters can be selected from the group consisting of brain-derived neurotrophic factor (BDNF), interleukin-7 (IL-7), interleukin-10 (IL-10), interleukin-13 (IL-13), interleukin-15 (IL-15), interleukin-18 (IL-18), fatty acid binding protein (FABP), alpha-1 antitrypsin (A1AT), beta-2 macroglobulin (B2M), factor VII, epithelial growth factor (EGF), alpha-2-macroglobulin (A2M), glutathione S-transferase (GST), RANTES, tissue inhibitor of matrix metalloproteinase-1 (TIMP-1), plasminogen activator inhibitor-1 (PAH), thyroxine, and cortisol, or can be selected from the group consisting of BDNF, A2M, IL-10, IL-13, IL-18, thyroxine, and cortisol. The parameters can be IL-7, A2M, IL-10, and IL-13; IL-7, IL-13, A2M, BDNF, and IL-18; IL-7, IL-10, IL-13, IL-15, A2M, GST, and IL-18; IL-10, IL-13, IL-15, A2M, BDNF, thyroxine, cortisol, and IL-18; IL-7, IL-13, IL-10, IL-15, IL-18, A2M, GST, and cortisol; or IL-7, IL-10, IL-13, IL-15, IL-18, A2M, GST, cortisol, and thyroxine.

The parameters can be selected from the group consisting of adrenocorticotropic hormone (ACTH), BDNF, cortisol, dopamine (DA), IL-1, IL-13, IL-18, norepinephrine (NE), thyroid-stimulating hormone (TSH), arginine vasopressin (AVP), and corticotropin-releasing hormone (CRH), or can be selected from the group consisting of cortisol, ACTH, IL-1, IL-18, BDNF, DA, leptin, TSH, CRH, and AVP. The parameters can be cortisol, ACTH, IL-1, IL-18, BDNF, leptin, TSH, CRH, and AVP; cortisol, ACTH, IL-1, IL-18, BDNF, TSH, CRH, and AVP; cortisol, ACTH, IL-1, IL-18, BDNF, TSH, and AVP; cortisol, ACTH, IL-1, BDNF, and TSH; or cortisol, ACTH, IL-1, IL-18, and BDNF. The parameters can further comprise neuropeptide Y (NPY) or platelet associated serotonin. The parameters can further comprise one or more biomarkers selected from the group consisting of IL-7, IL 10, IL-15, FABP, A1AT, B2M, factor VII, EGF, A2M, GST, RANTES, PAI-1, and TIMP-1.

The numerical values can be biomarker levels in a biological sample from the subject. The biological sample can be whole blood, serum, plasma, urine, or cerebrospinal fluid. The subject can be a human. The predetermined threshold can be statistical significance (e.g., p<0.05). The method can further comprise providing a numerical value for one or more parameters selected from the group consisting of magnetic resonance imaging, magnetic resonance spectroscopy, body mass index, measures of HPA activation, measures of thyroid function, measures of estrogen levels, or measures of testosterone levels. The method cam further comprise providing a biological sample from the subject, or measuring the plurality of parameters to obtain the numerical values.

In another aspect, this document features a method for diagnosing a depression disorder in a subject, comprising: (a) providing a biological sample from the subject; (b) measuring a plurality of parameters to obtain numerical values for the parameters, the parameters being predetermined to be relevant to depression; (c) individually weighting each of the numerical values by a predetermined function, each function being specific to each parameter; (d) determining the sum of the weighted values; (e) determining the difference between the sum and a control value; and (f) if the difference is greater than a predetermined threshold, classifying the subject as having depression, or, if the difference is not different than the predetermined threshold, classifying the subject as not having depression. The depression disorder can be major depressive disorder.

In another aspect, this document features a method for monitoring treatment for major depressive disorder (MDD), comprising: (a) providing numerical values for a plurality of parameters in a subject diagnosed as having MDD, the parameters being predetermined to be relevant to MDD; (b) using an algorithm comprising the numerical values to calculate an MDD score; (c) repeating steps (a) and (b) after a period of time during which the subject receives treatment for MDD, to obtain a post-treatment MDD score; (d) comparing the post-treatment MDD score from step (c) to the score in step (b) and to a MDD score for normal subjects, and classifying the treatment as being effective if the score from step (c) is closer than the score from step (b) to the MDD score for normal subjects. Step (b) can comprise individually weighting each of the numerical values by a predetermined function, each function being specific to each parameter, and calculating the sum of the weighted values.

The parameters can be selected from the group consisting of BDNF, IL-7, IL-10, IL-13, IL-15, IL-18, FABP, MAT, B2M, factor VII, EGF, A2M, GST, RANTES, TIMP-1, PAI-1, thyroxine, cortisol, and ACTH. The period of time can range from weeks to months after the onset of treatment. A subset of the numerical values can be provided for time points prior to and after initiation of the treatment. The parameters can comprise measurements derived from magnetic resonance imaging, magnetic resonance spectroscopy, or computerized tomography scans. The parameters can comprise body mass index, NPY, AVP, or a catecholamine or a urinary metabolite of a catecholamine. The numerical values can be biomarker levels in a biological sample from the subject. The biological sample can be serum, plasma, urine, or cerebrospinal fluid. The method can further comprise providing a biological sample from the subject. The method can further comprise measuring the levels of the plurality of parameters to obtain the numerical values.

In another aspect, this document features a method for monitoring treatment for major depressive disorder (MDD), comprising: (a) providing a biological sample from a subject diagnosed as having MDD; (b) measuring the levels of a plurality of analytes in the sample, the analytes being predetermined to be relevant to MDD; (c) using an algorithm comprising the measured levels to calculate an MDD score; (d) repeating steps (a), (b), and (c) after a period of time during which the subject receives treatment for MDD; (e) comparing the post-treatment MDD score from step (d) to the score in step (c) and to a MDD score for normal subjects, and classifying the treatment as being effective if the score from step (d) is closer than the score from step (c) to the MDD score for normal subjects.

In yet another aspect, a computer-implemented method is provided for diagnosing major depressive disorder (MDD). This method includes providing a biomarker library database that includes selected biomarker parameters that are predetermined to be relevant to MDD, sets of combinations of the biomarkers and coefficients the sets of combinations based on clinical data obtained from patients with MDD; and using a computer processor to apply a set of combination of the biomarkers and associated coefficients to measured values of the biomarker in the set obtained from a patient based on a predetermined algorithm to produce an MDD score for diagnosing whether the patient has MDD.

In another aspect, this document features a method for characterizing depression in a subject, comprising (a) providing numerical values for a plurality of parameters predetermined to be relevant to depression; (b) individually weighting each of said numerical values by a predetermined function, each function being specific to each parameter; (c) determining the sum of the weighted values; (d) determining the difference between said sum and a control value; and (e) if said difference is greater than a predetermined threshold, classifying said subject as having depression, or, if said difference is not different than said predetermined threshold, classifying said subject as not having depression. The depression can be associated with major depressive disorder (MDD).

The parameters can be selected from the group consisting of interleukin-1 (IL-1), interleukin-6 (IL-6), interleukin-7 (IL-7), interleukin-10 (IL-10), interleukin-13 (IL-13), interleukin-15 (IL-15), interleukin-18 (IL-18), alpha-2-macroglobin (A2M), and beta-2 macroglobulin (B2M), or from the group consisting of IL-1, IL-6, IL-7, IL-10, IL-13, IL-15, IL-18, and A2M. The parameters can be cortisol, IL-1, IL-6, IL-7, IL-10, IL-13, IL-18, and A2M; cortisol, IL-1, IL-6, IL-10, IL-13, IL-18, and A2M; IL-1, IL-10, IL-13, IL-18, and A2M; cortisol, IL-1, IL-10, IL-13, IL-18, and A2M; or cortisol, IL-10, IL-13, IL-18, and A2M. Any of the above groups of parameters can further include one or more of neuropeptide Y, ACTH, arginine vasopressin, brain-derived neurotrophic factor, and cortisol. The parameters can further include platelet associated serotonin. The parameters can further include serum or plasma levels of one or more of fatty acid binding protein, alpha-1 antitrypsin, factor VII, epidermal growth factor, glutathione S-transferase, RANTES, plasminogen activator inhibitor type 1, and tissue inhibitor of metalloproteinase type 1.

The numerical values can be biomarker levels in a biological sample from said subject. The biological sample can be whole blood, serum, plasma, urine, or cerebrospinal fluid. The predetermined threshold can be statistical significance (e.g., p<0.05). The subject can be a human.

The method can further comprise providing a numerical value for one or more parameters selected from the group consisting of magnetic resonance imaging, magnetic resonance spectroscopy, computerized tomography scanning, and body mass index. The method can further comprise providing a biological sample from said subject. The method can further comprise measuring said plurality of parameters to obtain said numerical values.

In another aspect, this document features a method for diagnosing a depression disorder in a subject, comprising: (a) providing a biological sample from the subject; (b) measuring a plurality of parameters to obtain numerical values for the parameters, the parameters being predetermined to be relevant to depression; (c) individually weighting each of the numerical values by a predetermined function, each function being specific to each parameter; (d) determining the sum of the weighted values; (e) determining the difference between the sum and a control value; and (f) if the difference is greater than a predetermined threshold, classifying the subject as having depression, or, if the difference is not different than the predetermined threshold, classifying the subject as not having depression. The depression disorder can be MDD.

In another aspect, this document features a method for monitoring treatment for MDD, comprising (a) providing numerical values for a plurality of parameters in a subject diagnosed as having MDD, said parameters being predetermined to be relevant to MDD; (b) using an algorithm comprising said numerical values to calculate an MDD score; (c) repeating steps (a) and (b) after a period of time during which said subject receives treatment for MDD, to obtain a post-treatment MDD score; (d) comparing the post-treatment MDD score from step (c) to the score in step (b) and to a MDD score for normal subjects, and classifying said treatment as being effective if the score from step (c) is closer than the score from step (b) to the MDD score for normal subjects. Step (b) can comprise individually weighting each of said numerical values by a predetermined function, each function being specific to each parameter, and calculating the sum of the weighted values.

The parameters can be selected from the group consisting of IL-I, IL-6, IL-7, IL-10, IL-13, IL-15, IL-18, A2M, and B2M. The period of time can range from weeks to months after the onset of said treatment. A subset of said numerical values can be provided for time points prior to and after initiation of said treatment. The parameters can comprise measurements derived from magnetic resonance imaging, magnetic resonance spectroscopy, or computerized tomography scans. The numerical values can be biomarker levels in a biological sample from said subject. The biological sample can be serum, plasma, urine, or cerebrospinal fluid.

The method can further comprise providing a biological sample from said subject. The method can further comprise measuring the levels of said plurality of parameters to obtain said numerical values.

In another aspect, this document features a method for monitoring treatment for MDD, comprising: (a) providing a biological sample from a subject diagnosed as having MDD; (b) measuring the levels of a plurality of analytes in the sample, the analytes being predetermined to be relevant to MDD; (c) using an algorithm comprising the measured levels to calculate an MDD score; (d) repeating steps (a), (b), and (c) after a period of time during which the subject receives treatment for MDD; (e) comparing the post-treatment MDD score from step (d) to the score in step (c) and to a MDD score for normal subjects, and classifying the treatment as being effective if the score from step (d) is closer than the score from step (c) to the MDD score for normal subjects.

In yet another aspect, this document features a computer-implemented method for diagnosing MDD. The method can include providing a biomarker library database that includes selected biomarker parameters that are predetermined to be relevant to MDD, sets of combinations of the biomarkers and coefficients, the sets of combinations based on clinical data obtained from patients with MDD; and using a computer processor to apply a set of combinations of the biomarkers and associated coefficients to measured values of the biomarkers in the set obtained from a patient based on a predetermined algorithm to produce an MDD score for diagnosing whether the patient has MDD.

In another aspect, this document features a method for assessing the likelihood that an individual has MDD, comprising

(a) identifying groups of biomarkers that may be related to MDD;

(b) obtaining clinical data from a plurality of subjects for the identified groups of biomarkers, wherein some of the subjects are diagnosed as having MDD and some of the subjects do not have MDD;

(c) applying optimization algorithms to the clinical data and calculating coefficients for selected biomarkers within each group;

(d) creating a hypermap by generating vectors for each group of selected biomarkers;

(e) measuring the levels of said selected biomarkers in one or more biological samples from said subject;

(f) applying said algorithms to said measured levels; and

(g) comparing the result of said algorithms for said individual to the hypermap to determine whether said individual is likely to have MDD, is not likely to have MDD, or falls into a sub-class that can be used to predict disease course, select a treatment regimen, or provide information regarding severity.

The method can further comprise, if it is determined in step (g) that said individual is likely to have MDD, comparing the result of hypermaps for said individual prior to and subsequent to therapy for said MDD, determining whether a change in biomarker pattern has occurred, and determining whether any such change is reflected in the clinical status of the individual.

The groups of biomarkers can include two or more inflammatory biomarkers, HPA axis biomarkers, metabolic biomarkers, or neurotrophic biomarkers. The inflammatory biomarkers can be selected from the group consisting of alpha 1 antitrypsin, alpha 2 macroglobulin, apolipoprotein CIII, CD40 ligand, interleukin 6, interleukin 13, interleukin 18, interleukin 1 receptor antagonist, myeloperoxidase, plasminogen activator inhibitor-1, RANTES (CCL5), tumor necrosis factor alpha (TNFα), sTNFRI, and sTNFRII. The HPA axis biomarkers can be selected from the group consisting of cortisol, epidermal growth factor, granulocyte colony stimulating factor, pancreatic polypeptide, adrenocorticotropic hormone, arginine vasopressin, and corticotropin-releasing hormone. The metabolic biomarkers can be selected from the group consisting of adiponectin, acylation stimulating protein, fatty acid binding protein, insulin, leptin, prolactin, resistin, testosterone, and thyroid stimulating hormone. The neurotrophic biomarkers can be selected from the group consisting of brain-derived neurotrophic factor, S100B, neurotrophin 3, glial cell line-derived neurotrophic factor, artemin, and reelin and its isoforms.

In still another aspect, this document features a method for determining whether a human subject has depression, comprising (a) providing numerical values for a plurality of parameters predetermined to be relevant to depression, wherein the plurality of parameters comprises one or more hypothalamic-pituitary-adrenal (HPA) axis markers and one or more metabolic markers; (b) individually weighting each of the numerical values by a predetermined function, each function being specific to each parameter; (c) determining the sum of the weighted values; (d) determining the difference between the sum and a control value; and (e) if the difference is greater than a predetermined threshold, classifying the individual as having depression, or, if the difference is not different than the predetermined threshold, classifying the individual as not having depression. The depression can be associated with major depressive disorder (MDD).

An algorithm can be used to calculate an MDD score that can be used to support the diagnosis of MDD. The HPA axis markers can be selected from the group consisting adrenocorticotropic hormone, cortisol, epidermal growth factor, granulocyte colony stimulating factor, pancreatic polypeptide, vasopressin, and corticotrophin releasing hormone, and the metabolic markers are selected from the group consisting of acylation stimulating protein, adiponectin, apolipoprotein CIII, C-reactive protein, fatty acid binding protein, prolactin, resistin, insulin, testosterone, and thyroid stimulating hormone. The plurality of parameters can comprise clinical measurements relevant to metabolic syndrome (e.g., clinical measurements are selected from the group consisting of body mass index, fasting glucose levels, blood pressure, central obesity, high density lipoprotein, and triglycerides). The plurality of parameters can comprise the level of one or more catecholamines or catecholamine metabolites in urine, one or more inflammatory biomarkers, and/or one or more neurotrophic biomarkers.

In another aspect, this document features a method for monitoring treatment of an individual diagnosed with a depression disorder, comprising (a) using an algorithm to determine a first MDD disease score based on the levels of a plurality of analytes in a biological sample from the individual, wherein the plurality of analytes comprise one or more HPA axis biomarkers and one or more metabolic biomarkers; (b) using the algorithm to determine a second MDD disease score after treatment of the individual for the depression disorder; (c) comparing the score in step (a) to the score in step (b) and to a control MDD disease score, and classifying the treatment as being effective if the score in step (b) is closer than the score in step (a) to the control MDD score, or classifying the treatment as not being effective if the score in step (b) is not closer than the score in step (a) to the control MDD score. The second MDD disease score can be determined weeks or months after treatment. Steps (b) and (c) can be repeated over time to monitor the individual's response to treatment, the change in the individual's MDD status, or the progression of MDD in the individual. A subset of the plurality of analytes can be measured at time points prior to and after the initiation of treatment.

The method can further comprise including in the algorithm parameters comprising clinical measurements relevant to metabolic syndrome (e.g., clinical measurements selected from the group consisting of body mass index, fasting glucose levels, blood pressure, central obesity, high density lipoprotein, and triglycerides). The biological sample can be serum, plasma, or cerebrospinal fluid. The biomarkers can be nucleic acids and the biological sample can be comprised of cells or tissue. The plurality of analytes can comprise the level of one or more catecholamines or catecholamine metabolites in urine. The one or more metabolic biomarkers can comprise one or more thyroid hormones, or testosterone. The plurality of analytes can comprise one or more inflammatory biomarkers and/or one or more neurotrophic biomarkers. The method can further comprise adjusting the treatment of the individual if the score in step (b) is not closer than the score in step (a) to the control MDD score. The control MDD score can be an MDD score calculated for a normal individual or the average of MDD scores calculated for a plurality of normal individuals.

In still another aspect, this document features a method for determining whether an individual is likely to have depression, comprising (a) providing a biological sample from the individual; (b) measuring the level of an analyte in the biological sample, wherein the analyte is selected from the group consisting of apolipoprotein CIII, epidermal growth factor, prolactin, and resistin; (c) comparing the measured level with a control level of the analyte; and (d) if the level of the analyte is greater than the control level, classifying the individual as likely to have depression, or if the level of the analyte is not greater than the control level, classifying the individual as not likely to have depression. The biological sample can be, for example, a serum sample. The depression can be associated with MDD.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of the HPA axis, indicating the complicated level of feedback responses and points where changes in the levels of mediators (both peripheral and in the central nervous system) can lead to the changes observed in depressed patients. AVP=arginine vasopressin; CRF=corticotrophin releasing factor.

FIG. 2 is a flow diagram outlining the steps in a method for selection of biomarkers.

FIG. 3 is a flow diagram showing the steps in an exemplary method for developing a disease specific library or panel with an algorithm for diagnostic development.

FIG. 4 is a flow diagram showing steps in a method for developing a basic diagnostic score, where n diagnostic scores are generated. Diagnostic score Sn=Fn(C1, . . . Cn, M1, . . . Mn), where Sn is the nth score and Fn is the nth function, and Cn and Mn are the nth coefficient and nth marker expression level, respectively.

FIG. 5 is a flow diagram outlining steps in a method for using blood to diagnose, select treatment, monitor treatment efficacy, and optimize therapy. Diagnostic score Sn=Fn(C1, . . . Cn, M1, . . . Mn), where Sn is the nth score and Fn is the nth function, and Cn and Mn are the nth coefficient and nth marker expression level, respectively.

FIG. 6 is a diagram depicting steps that can be included in some embodiments of a method for generating a hypermap for particular disease.

FIG. 7 is a diagram depicting steps that can be included in some embodiments of a process for constructing a hypermap from selected groups of markers and clinical data for a particular disease.

FIG. 8 shows an example of a computer-based diagnostic system employing the biomarker analysis described in this document.

FIG. 9 shows an example of a computer system that can be used in the system in FIG. 8.

FIG. 10 is a box whisker plot indicating serum levels of hypothetical biomarker protein X in normal subjects and MDD patients before and after the initiation of treatment. The box represents the 25^{th}-75^{th} percentile. The line drawn within the box is the median concentration of the marker, and the whiskers are the 5^{th} and 95^{th} percentiles. Each dot represents an individual patient value.

FIG. 11 is a box whisker plot of apolipoprotein CIII in serum samples from 50 depressed patients and 20 age-matched normal controls. Data are presented as in FIG. 10.

FIG. 12 is a box whisker plot of epidermal growth factor (EGF) in serum samples from 50 depressed patients and 20 age-matched normal controls. Data are presented as in FIG. 10.

FIG. 13 is a box whisker plot of prolactin in serum samples from 50 depressed patients and 20 age-matched normal controls. Data are presented as in FIG. 10.

FIG. 14 is a box whisker plot of resistin in serum samples from 50 depressed patients and 20 age-matched normal controls. Data are presented as in FIG. 10.

FIG. 15 is a box whisker plot indicating serum levels of pancreatic polypeptide in control and MDD patients, and MDD patients treated with antidepressants. Data are presented as in FIG. 10.

FIG. 16 is a hypermap representation of patients diagnosed with MDD (asterisks) and a normal control group (circles).

FIG. 17 is a graph illustrating the results of applying a formula to a set of clinical samples from MDD patients (black bars) as compared to age-matched healthy normal subjects (gray bars). The test score represents 10 times the probability that a subject has MDD (10×PMDD).

FIG. 18 is a hypermap representation of clinical data from a longitudinal study of a group of drug naïve MDD patients whose sera were tested prior to and 2 and 8 weeks after initiation of therapy with the antidepressant LEXAPRO™. Vectors indicate the change in the biomarker pattern subsequent to treatment.

### DETAILED DESCRIPTION

MDD, also known as major depression, unipolar depression, clinical depression, or simply depression, is a mental disorder characterized by a pervasive low mood and loss of interest or pleasure in usual activities. A diagnosis of MDD typically is made if a person has suffered one or more major depressive episodes. MDD affects nearly 19 million Americans annually. The most common age of onset is between 30 and 40 years, with a later peak between 50 and 60 years of age. Diagnosis generally is based on a subject's self-reported experiences and observed behavior. Biobehavioral research, however, is among the most challenging of scientific endeavors, since biological organisms display wide-ranging individual differences in physiology. In particular, the paradigm used for neuropsychiatric diagnosis and patient management is based on clinical interviews to stratify patients within adopted classifications. This paradigm has the caveat of not including information derived from biological or pathophysiological mechanisms.

The development of psychotropic drugs has relied on quantification of disease severity through psychopathological parameters (e.g., the Hamilton scale for depression). Subjective factors and lack of a proper definition inevitably influence such parameters. Similarly, diagnostic parameters for enrollment of psychiatric patients in phase II and phase III clinical studies are centered on the assessment of disease severity and specificity by measurement of symptomatological scales, and there are no validated biological correlates for disease trait and state that could help in patient selection. In spite of recent progress in molecular diagnostics, the potential information contained within the patient genotype on the likely phenotypic response to drug treatment has not been effectively captured, particularly in non-research settings.

The techniques described herein are based in part on the identification of methods for establishing a diagnosis of, predisposition to, and prognosis for depression disorder conditions, as well as methods for monitoring treatment of subjects diagnosed with and treated for a depression disorder condition. The methods provided herein can include developing an algorithm, evaluating (e.g., measuring) multiple parameters, and using the algorithm to determine a set of quantitative diagnostic scores. Algorithms for application of multiple biomarkers from biological samples such as serum or plasma can then be applied to patient stratification, and also can be used for identification of pharmacodynamic markers. The approach described herein differs from more traditional approaches to biomarkers in the construction of an algorithm, rather than measuring changes in single markers or groups of single markers at multiple time points.

As used herein, a “biomarker” is a characteristic that can be objectively measured and evaluated as an indicator of a biologic or pathogenic process or a pharmacological response to therapeutic intervention. Biomarkers can be, for example, proteins, nucleic acids, metabolites, physical measurements, or combinations thereof. A “pharmacodynamic” biomarker is a biomarker that can be used to quantitatively evaluate (e.g., measure) the impact of treatment or therapeutic intervention on the course, severity, status, symptomology, or resolution of a disease. As used herein, an “analyte” is a substance or chemical constituent that can be objectively measured and determined in an analytical procedure such as immunoassay or mass spectrometry. An analyte thus can be a type of biomarker.

### Algorithms

Algorithms for determining diagnosis, prognosis, status, or response to treatment, for example, can be determined for any clinical condition. The algorithms used in the methods provided herein can be mathematic functions incorporating multiple parameters that can be quantified using, without limitation, medical devices, clinical evaluation scores, or biological/chemical/physical tests of biological samples. Each mathematic function can be a weight-adjusted expression of the levels of parameters determined to be relevant to a selected clinical condition. Because of the complexity of the weighting and the multiple marker panels, computers with reasonable computational power typically are required to analyze the data. Algorithms generally can be expressed in the format of Formula 1:

Diagnostic score=f(x1,x2,x3,x4,x5 . . . xn) (1)

A diagnostic score is a value that is the diagnostic or prognostic result, “f” is any mathematical function, “n” is any integer (e.g., an integer from 1 to 10,000), and x1, x2, x3, x4, x5 . . . xn are the “n” parameters that are, for example, measurements determined by medical devices, clinical evaluation scores, and/or tests results for biological samples (e.g., human biological samples such as blood, urine, or cerebrospinal fluid).

The parameters of an algorithm can be individually weighted. An example of such an algorithm is expressed in Formula 2:

Diagnostic score=a1*x1+a2*x2−a3*x3+a4*x4−a5*x5 (2)

Here, x1, x2, x3, x4, and x5 can be measurements determined by medical devices, clinical evaluation scores, and/or test results for biological samples (e.g., human biological samples), and a1, a2, a3, a4, and a5 are weight-adjusted factors for x1, x2, x3, x4, and x5, respectively.

A diagnostic score can be used to quantitatively define a medical condition or disease, or the effect of a medical treatment. For example, an algorithm can be used to determine a diagnostic score for a disorder such as depression. In such an embodiment, the degree of depression can be defined based on Formula 1, with the following general formula:

Depression diagnosis score=f(x1,x2,x3,x4,x5 . . . xn)

The depression diagnosis score is a quantitative number that can be used to measure the status or severity of depression in an individual, “f” is any mathematical function, “n” can be any integer (e.g., an integer from 1 to 10,000), and x1, x2, x3, x4, x5 . . . xn are, for example, the “n” parameters that are measurements determined using medical devices, clinical evaluation scores, and/or test results for biological samples (e.g., human biological samples).

In a more general format, multiple diagnostic scores Sm can be generated by applying multiple formulas to a group of biomarker measurements, as illustrated in equation (3)

Scores Sm=fm(x1, . . . xn) (3)

Multiple scores can be useful, for example, in the identification of specific types of depression disorders and/or associated disorders, such as sub-types of MDD and/or related or unrelated disorders. Some multiple scores also can be parameters indicating patient treatment progress and/or the utility of the treatment selected. For depression disorder, a treatment progress score can help a health care professional (e.g., a doctor or other clinician) adjust treatment doses and duration. A sub-indication score also can help a health care professional to select optimal drugs or combinations of drugs to use for treatment. By way of example, it has been shown that a link exists between depressed mood and hypothyroidism, and it has been estimated that more than a third of people suffering from depression are hypothyroid. A biomarker panel including elements whose measurements may be indicative of hypothyroid function (e.g., anti-thyroid antibodies, T3, T4, TSH) can be used to calculate a score indicative of hypothyroidism. Combining these data with one or more panels indicative of MDD can allow a clinician to choose a regimen for treating both MDD and hypothyroidism. Cumulative experience based upon measurements with multiple biomarker panels and the success of treatment regimens can provide additional insight into the choice of a regimen.

For major depressive disorder and other mood disorders, treatment monitoring can help a clinician adjust treatment dose(s) and duration. An indication of a subset of alterations in individual biomarker levels that more closely resemble normal homeostasis can assist a clinician in assessing the efficacy of a regimen. Similarly, subclassification of a patient can be valuable in choosing an optimal drug or combination of drugs to use as a treatment regimen. Such changes, indicative of clinical efficacy, also can be useful to pharmaceutical companies during the development of new drugs.

### Building Biomarker Libraries

To determine which parameters are useful for inclusion in a diagnostic algorithm, a biomarker library of analytes can be developed, and individual analytes from the library can be evaluated for inclusion in an algorithm for a particular clinical condition. In the initial phases of biomarker library development, the focus can be on broadly relevant clinical content, such as analytes indicative of inflammation, Th1 and Th2 immune responses, adhesion factors, and proteins involved in tissue remodeling (e.g., matrix metalloproteinases (MMPs) and tissue inhibitors of matrix metalloproteinases (TIMPs)). In some embodiments (e.g., during initial library development), a library can include a dozen or more markers, a hundred markers, or several hundred markers. For example, a biomarker library can include a few hundred protein analytes. As a biomarker library is built, new markers can be added (e.g., markers specific to individual disease states, and/or markers that are more generalized, such as growth factors). In some embodiments, analytes can be added to expand the library and to increase specificity beyond the inflammation, oncology, and neuropsychological foci by addition of disease related proteins obtained from discovery research (e.g., using differential display techniques, such as isotope coded affinity tags (ICAT), mass spectroscopy, accurate mass, and time tags). Matrix-assisted laser desorption and ionization (MALDI) and surface enhanced laser desorption/ionization (SELDI) mass spectrometry can provide high-resolution measurements useful for protein biomarker identification and quantification.

The addition of a new analyte to a biomarker library can require a purified or recombinant molecule, as well as the appropriate antibody (or antibodies) to capture and detect the new analyte. It is noted that while application of a biomarker library to conventional ELISA platforms can require multiple antibodies for each analyte, a Molecular interaction Measurement System (MIMS) developed by Ridge Diagnostics, Inc. (Research Triangle Park, NC; formerly Precision Human Biolaboratories, Inc.) can be operated to use a single specific antibody for each analyte. Addition of a new nucleic acid-based analyte to a biomarker library can require the identification of a specific mRNA, as well as probes and detection systems to quantify the expression of that specific RNA. Although discovery of individual “new or novel” biomarkers is not necessary for developing useful algorithms, such markers can be included. Platform technologies that are suitable for multiple analyte detection methods as described herein typically are flexible and open to addition of new analytes. For example, the MIMS platform and other technologies that are suitable for multiple analyte detection methods typically are flexible and open to addition of new analytes. The MIMS platform is a label-free system based on optical sensing and certain features of the MIMI are described in PCT Application No. PCT/US2006/047244 entitled “Optical Molecular Detection” and was published as PCT Publication No. WO 2007/067819, which is incorporated by reference in its entirety as part of the disclosure of this document.

While this document indicates that multiplexed detection systems can provide robust and reliable measurement of analytes relevant to diagnosing, treating, and monitoring clinical conditions, this does not preclude the use of assays capable of measuring the concentration of individual analytes from the panel (e.g., a series of single analyte ELISAs). The biomarker panels can be expanded and transferred to traditional protein arrays, multiplexed bead platforms or label-free arrays, and algorithms (e.g., computer-based algorithms) can be developed to support clinicians and clinical research.

Custom antibody array(s) can be designed, developed, and analytically validated for about 25-50 antigens. Initially, a panel of about 5 to 10 (e.g., 5, 6, 7, 8, 9, or 10) analytes can be chosen based on their ability to, for example, distinguish affected from unaffected subjects, or to distinguish between stages of disease in patients from a defined sample set. An enriched database, however, usually one in which more than 10 significant analytes are measured, can increase the sensitivity and specificity of test algorithms. Other panels can be run in addition to the panel reflecting HPA axis activity and metabolic syndrome, to further define the disease state or sub-classify patients. By way of example, data obtained from measurements of neurotrophic factors can discern patients with alterations in neuroplasticity. It is noted that such approaches also can include or be applied to other biological molecules including, without limitation, DNA and RNA.

### Selecting Individual Parameters

In the construction of libraries or panels, markers and parameters can be selected using any of a variety of methods. The primary driver for construction of a disease specific library or panel can be knowledge of a parameter's relevance to the disease. To construct a library for diabetes, for example, understanding of the disease would likely warrant the inclusion of blood glucose levels. Literature searches or experimentation also can be used to identify other parameters/markers for inclusion. In the case of diabetes, for example, a literature search might indicate the potential usefulness of hemoglobin A1c (HbAC), while specific knowledge or experimentation might lead to inclusion of the inflammatory markers tumor necrosis factor (TNF)-α receptor 2 (sTNF-RII), interleukin (IL)-6, and C-reactive protein (CRP), which have been shown to be elevated in subjects with type II diabetes.

In some embodiments, parameters that can be used to calculate a depression diagnosis score can include immune system biomarkers. Studies have indicated that inflammation, cytokines, and chemokines may be linked to depression. For example, treatment of patients with cytokines can produce symptoms of depression. Activation of the immune system is observed in many depressed patients, and depression occurs more frequently in those having medical disorders associated with immune dysfunction. Further, activation of the immune system and administration of endotoxin (LPS) or interleukin-1 (IL-1) to animals induces sickness behavior resembling depression, while chronic treatment with antidepressants can inhibit sickness behavior induced by LPS. In addition, several cytokines can activate the HPA axis, which is commonly activated in depressed patients; some cytokines can activate cerebral noradrenergic systems (also commonly observed in depressed patients); and some cytokines/chemokines can activate brain serotonergic systems, which have been implicated in major depressive illness and its treatment.

A wide variety of proteins are involved in inflammation, and any one of them is open to a genetic mutation that impairs or otherwise disrupts the normal expression and function of that protein. Inflammation also induces high systemic levels of acute-phase proteins. These proteins include C-reactive protein, serum amyloid A, serum amyloid P, vasopressin, and glucocorticoids, which cause a range of systemic effects. Inflammation also involves release of proinflammatory cytokines and chemokines.

The immune system has a complex and dynamic relationship with the nervous system, both in health and disease. The immune system surveys the central and peripheral nervous systems, and can be activated in response to foreign proteins, infectious agents, stress, and neoplasia. Conversely, the nervous system modulates immune system function both through the neuroendocrine axis and through vagus nerve efferents. When this dynamic relationship is perturbed, neuropsychiatric diseases can result. In fact, several medical illnesses that are characterized by chronic inflammatory responses (e.g., rheumatoid arthritis) have been reported to be accompanied by depression. In addition, administration of proinflammatory cytokines (e.g., in cancer or hepatitis C therapies) can induce depressive symptomatology. Administration of proinflammatory cytokines in animals induces “sickness behavior,” which is a pattern of behavioral alterations that is very similar to the behavioral symptoms of depression in humans. Thus, the “Inflammatory Response System (IRS) model of depression” (Macs (1999) Adv. Exp. Med. Biol. 461:25-46) proposes that proinflammatory cytokines, acting as neuromodulators, represent key factors in mediation of the behavioral, neuroendocrine and neurochemical features of depressive disorders.

Other classes of biomarkers that may be useful in an algorithm for determining a MDD score include, for example, neurotrophic biomarkers, metabolic biomarkers, and HPA axis biomarkers. The HPA axis (also referred to as the HPTA axis) is a complex set of direct influences and feedback interactions between the hypothalamus (a hollow, funnel-shaped part of the brain), the pituitary gland (a pea-shaped structure located below the hypothalamus), and the adrenal or suprarenal gland (a small, paired, pyramidal organ located at the top of each kidney). The fine, homeostatic interactions between these three organs constitute the HPA axis, which is a major part of the neuroendocrine system that controls reactions to stress and regulates body processes including digestion, the immune system, mood and sexuality, and energy usage.

The HPA axis (also referred to as the HTPA axis) is a complex set of direct influences and feedback interactions between the hypothalamus, the pituitary gland, and the adrenal glands. The fine, homeostatic interactions between these three organs constitute the HPA axis, a major part of the neuroendocrine system that controls reactions to stress and regulates various body processes including digestion, the immune system, mood and sexuality, and energy usage. Hypercortisolemia has been observed in patients with major depression (see, e.g., Carpenter and Bunney (1971) Am. J. Psychiatry 128:31; Carroll (1968) Lancet 1:1373; and Plotsky et al. (1998) Psychiatr. Clin. North Am. 21:293-307). True hypercortisolemia and dysregulation of the HPA axis can be found in severe forms of depression, and elements of the HPA axis appear to be state rather than trait markers, in that they respond to external stimuli.

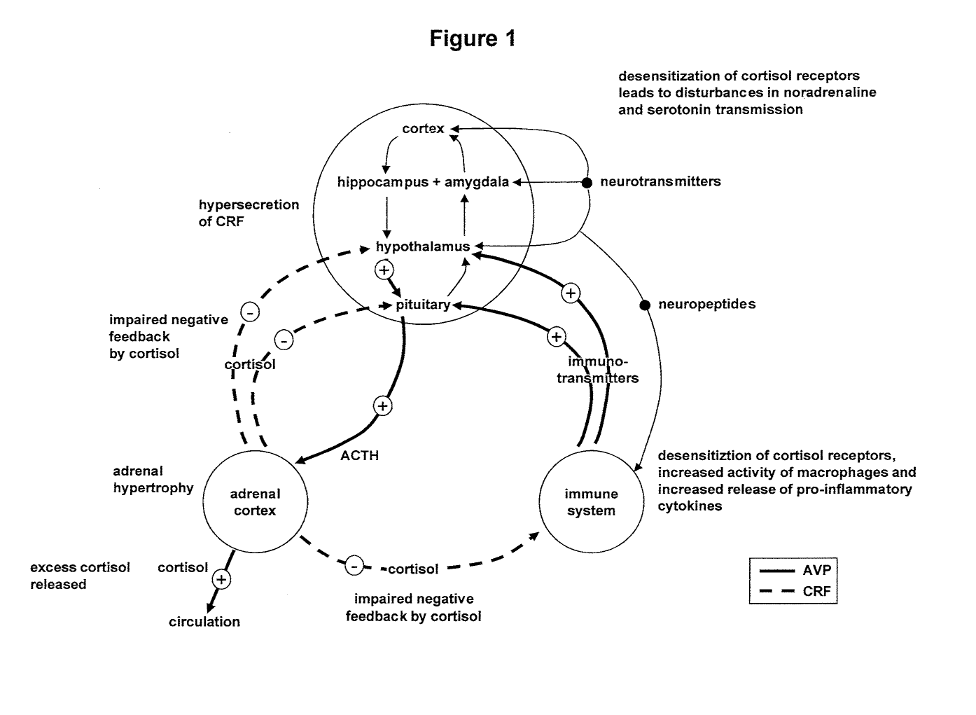

As shown in FIG. 1, HPA axis activity is governed by the secretion of corticotropin-releasing hormone (CRH or CRF) from the hypothalamus. CRH activates the secretion of adrenocorticotropic hormone (ACTH) from the pituitary. ACTH, in turn, stimulates the secretion of glucocorticoids (cortisol in humans) from the adrenal glands. Release of cortisol into the circulation can have a number of effects, including elevation of blood glucose. The negative feedback of cortisol to the hypothalamus, pituitary and immune system is impaired, leading to continual activation of the HPA axis and excess cortisol release. Cortisol receptors become desensitized, leading to increased activity of the pro-inflammatory immune mediators and disturbances in neurotransmitter transmission.

Depressed patients can have elevated basal serum cortisol levels and CRH in cerebrospinal fluid (CSF). A number of neuroendocrine challenge tests have probed functioning at various levels of the HPA axis. Depressed patients can have non-suppression of cortisol in the dexamethasone suppression test (DST), a blunted ACTH but normal cortisol response to CRH, and an exaggerated ACTH and cortisol response to CRH after pre-treatment with dexamethasone (Dex/CRH test). Such a pattern of HPA dysfunction, often referred to as “hyperactivity,” can be useful as part of an algorithm to calculate a disease score.

Soluble factors, or cytokines, emanating from the immune system can have profound effects on the neuroendocrine system, in particular the HPA axis. HPA activation by cytokines (via the release of glucocorticoids) in turn has been found to play a critical role in restraining and shaping immune responses. Thus, cytokine-HPA interactions represent a fundamental consideration regarding the maintenance of homeostasis, which may be compromised in disease.

Biomarkers for characterizing dysfunctional changes in the HPA axis can include one or more of adrenocorticotropic hormone (ACTH), BDNF, cortisol, DA, IL-1, IL-18, serotonin, norepinephrine, thyroid-stimulating hormone (TSH), vasopressin, and corticotropin-releasing hormone (CRH). The numerical values can be biomarker levels in a biological sample from the subject. The biological sample can be whole blood, serum, plasma, urine, or cerebrospinal fluid. The subject can be a human. The predetermined threshold can be statistical significance (e.g., p<0.05). Methods for determining statistical significance can include those routinely used in the art, for example: a t-statistic, a chi-square statistic, an F-statistic, etc.

Metabolic biomarkers as defined herein refer to markers related to general health and regulation of metabolic processes, including energy metabolism. Among the possible metabolic markers that can be monitored are biomarkers related to metabolic syndrome, which is a combination of medical disorders that increase the risk of developing cardiovascular disease and diabetes. It has been suggested that depression may lead to development of cardiovascular disease through its association with metabolic syndrome. While little is known about the biochemical relationship between depression and metabolic syndrome, however, it was observed that women with a history of a major depressive episode were twice as likely to have the metabolic syndrome compared with those with no history of depression (Kinder et al. (2004) Psychosomatic Medicine 66:316-322).

The following tables provide examples of analytes that can be measured and included in a MDD algorithm, as described further in the Examples herein.

### Inflammatory Biomarkers

A large variety of proteins are involved in inflammation, and all are open to genetic mutations that can impair or otherwise dysregulate normal expression and function. Inflammation also induces high systemic levels of acute-phase proteins. These include C-reactive protein, serum amyloid A, serum amyloid P, vasopressin, and glucocorticoids, which can cause a range of systemic effects. In addition, proinflammatory cytokines and chemokines are involved in inflammation. Table 1 provides an exemplary list of inflammatory biomarkers.

### HPA Axis Biomarkers

The hypothalamic-pituitary-adrenal axis (HPA or HTPA axis), also known as the limbic-hypothalamic-pituitary-adrenal axis (LHPA axis), is a complex set of direct influences and feedback interactions among the hypothalamus, the pituitary gland, and the adrenal (or suprarenal) glands. The interactions among these organs constitute the HPA axis, a major part of the neuroendocrine system that controls reactions to stress and regulates many body processes, including digestion, the immune system, mood and emotions, sexuality, and energy storage and expenditure. Examples of HPA biomarkers include ACTH and cortisol, as well as others listed in Table 2.

### Metabolic Biomarkers

Metabolic biomarkers provide insight into metabolic processes in wellness and disease states. Human diseases manifest in complex downstream effects, affecting multiple biochemical pathways. Proteins and hormones controlling these processes, as well as metabolites can be used for diagnosis and patient monitoring. Table 3 provides an example of a list of metabolic biomarkers that can be assessed using the methods described herein.

### Neurotrophic Factors

Neurotrophic factors are a family of proteins that are responsible for the growth and survival of developing neurons and the maintenance of mature neurons. Neurotrophic factors have been shown to promote the initial growth and development of neurons in the central nervous system (CNS) and peripheral nervous system (PNS), and to stimulate regrowth of damaged neurons in test tubes and animal models. Neurotrophic factors often are released by the target tissue in order to guide the growth of developing axons. Most neurotrophic factors belong to one of three families: (1) neurotrophins, (2) glial cell-line derived neurotrophic factor family ligands (GFLs), and (3) neuropoietic cytokines. Each family has its own distinct signaling pathway, although the cellular responses that are elicited often overlap. An exemplary list of neurotrophic biomarkers is presented in Table 4. Reelin is a protein that helps regulate processes of neuronal migration and positioning in the developing brain. Besides this important role in early development, reelin continues to work in the adult brain by modulating synaptic plasticity by enhancing the induction and maintenance of long-term potentiation. Reelin has been implicated in the pathogenesis of several brain diseases. Significantly lowered expression of the protein has been observed in schizophrenia and psychotic bipolar disorder. Serum levels of certain reelin isoforms may differ in MDD and other mood disorders, such that measurement of reelin isoforms can enhance the ability to distinguish MDD from bipolar disease and schizophrenia, as well as further sub-classify patient populations.

TABLE 1

| Gene Symbol | Gene Name | Cluster |
|---|---|---|
| A1AT | Alpha 1 Antitrypsin | Inflammation |
| A2M | Alpha 2 Macroglobulin | Inflammation |
| AGP | Alpha 1-Acid Glycoprotein | Inflammation |
| ApoC3 | Apolipoprotein CIII | Inflammation |
| CD40L | CD40 ligand | Inflammation |
| IL-1(α or β) | Interleukin 1 | Inflammation |
| IL-6 | Interleukin 6 | Inflammation |
| IL-13 | Interleukin 13 | Inflammation |
| IL-18 | Interleukin 18 | Inflammation |
| IL-1ra | Interleukin 1 Receptor Antagonist | Inflammation |
| MPO | Myeloperoxidase | Inflammation |
| PAI-1 | Plasminogen activator inhibitor-1 | Inflammation |
| RANTES | RANTES (CCL5) | Inflammation |
| TNFA | Tumor Necrosis Factor alpha | Inflammation |
| STNFR | Soluble TNFα receptor (I, II) | Inflammation |

TABLE 2

| Gene Symbol | Gene Name | Cluster |
|---|---|---|
| None | Cortisol | HPA axis |
| EGF | Epidermal Growth Factor | HPA axis |
| GCSF | Granulocyte Colony Stimulating Factor | HPA axis |
| PPY | Pancreatic Polypeptide | HPA axis |
| ACTH | Adrenocorticotropic hormone | HPA axis |
| AVP | Arginine Vasopressin | HPA axis |
| CRH | Corticotropin-Releasing Hormone | HPA axis |

TABLE 3

| Gene Symbol | Gene Name | Cluster |
|---|---|---|
| ACRP30 | Adiponectin | Metabolic |
| ASP | Acylation Stimulating Protein | Metabolic |
| FABP | Fatty Acid Binding Protein | Metabolic |
| INS | Insulin | Metabolic |
| LEP | Leptin | Metabolic |
| PRL | Prolactin | Metabolic |
| RETN | Resistin | Metabolic |
| None | Testosterone | Metabolic |
| TSH | Thyroid Stimulating Hormone | Metabolic |
| None | Thyroxine | Metabolic |

TABLE 4

| Gene Symbol | Gene Name | Cluster |
|---|---|---|
| BDNF | Brain-derived neurotrophic factor | Neurotrophic |
| S100B | S100B | Neurotrophic |
| NTF3 | Neurotrophin 3 | Neurotrophic |
| RELN | Reelin | Neurotrophic |
| GDNF | Glial cell line derived neurotrophic factor | Neurotrophic |
| ARTN | Artemin | Neurotrophic |

The following paragraphs provide further information regarding examples of analytes that can be measured and included in a MDD algorithm, as described further in the Examples herein.

A1AT: Reduced activity of peptidases, such as prolylendopeptidase (PEP) and dipeptidyl peptidase IV (DPP IV), occurs in depression. There are studies indicating that increased plasma concentrations of alpha-1 antitrypsin are found in severely depressed subjects as compared with healthy controls, with minor depressives exhibiting an intermediate position (Maes (1992) J. Affect. Disord. 24:183-192).

A2M: A2M is a serum pan-protease inhibitor and an acute phase protein that has been associated with inflammatory disease. A2M also has been implicated in Alzheimer disease based on its ability to mediate the clearance and degradation of A beta, the major component of beta-amyloid deposits. Non-melancholic depressive patients have showed increased A2M serum concentrations in the acute stage of disease and after 2 and 4 weeks of treatment (Kirchner (2001) J. Affect. Disord. 63:93-102).

ACTH: ACTH (also referred to as corticotropin) is a polypeptide hormone produced and secreted by the pituitary gland. It is an important player in the hypothalamic-pituitary-adrenal axis. ACTH stimulates the cortex of the adrenal gland and boosts the synthesis of corticosteroids, mainly glucocorticoids but also sex steroids (androgens). Plasma ACTH can be elevated particularly in patients with hypercortisolemia.

AVP: Previous studies have reported abnormalities of neurohypophyseal secretions in major depressive disorder. One of these secretions is AVP, which has been related to MDD in several studies, and particularly in patients with certain subclasses of depression (e.g., melancholic, anxiety-related). Vasopressin, as the name indicates, increases the resistance of the peripheral vessels and thus increases arterial blood pressure. Animal studies have shown that AVP functions as a neuromodulator of the stress response. Human studies have shown that plasma concentrations of AVP increase or decrease under different conditions of stress, whereas normal release is controlled by osmo- and volume receptors. Lastly, plasma levels of AVP were shown to be elevated in patients with MDD (van Londen et al. (1997) Neuropsychopharm. 17:284-292). Measuring AVP levels thus may contribute to the ability to segregate and monitor therapy.

B2M: B2M is a small (99 amino acid) protein that plays a key role in immunological defense. B2M can be modified by removal of the lysine at position 58, leaving the protein with two disulfide-linked chains of the amino acids 1-57 and 59-99. This modified form (desLys-58-β2-microglobulin, or ΔK58-β2m) has been shown to be associated with chronic inflammatory conditions (Nissen (1993) Danish Med. Bul. 40:56-64). B2M has been found to correlate with disease activity in several autoimmune disorders, and is used as a pharmacodynamic marker of interferon beta treatment in multiple sclerosis.

BDNF: BDNF is highly involved in regulation of the HPA axis. In addition, BDNF levels are reduced in depressed patients as compared to controls, and antidepressant treatment can increase serum BDNF levels in depressed patients. The level of plasma BDNF also can be increased with electroconvulsive therapy, suggesting that non-drug therapy can modulate BDNF levels (Marano et al. (2007) J. Clin. Psych. 68:512-7). Univariate analysis (see Example 1 below) identified BDNF as a marker with statistical significance, but the ranges of BDNF levels for the two groups overlap significantly, indicating that serum BDNF by itself is not a good predictor of MDD.

Cortisol: Cortisol is a corticosteroid hormone produced by the adrenal cortex of the adrenal gland. Cortisol is a vital hormone that is often referred to as the “stress hormone,” as it is involved in the response to stress. This hormone increases blood pressure and blood sugar levels, and has an immunosuppressive action. Cortisol inhibits secretion of CRH, resulting in feedback inhibition of ACTH secretion. This normal feedback system may break down when humans are exposed to chronic stress, and may be an underlying cause of depression. Hypercortisolism in depression has been reported, as reflected by elevated mean 24-hour serum cortisol concentrations and increased 24-hour urinary excretion of cortisol. In addition, prolonged hypercortisolemia may be neurotoxic, and recurrent depression episodes associated with elevated cortisol may lead to progressive brain damage.

CRH: CRH, originally named corticotropin-releasing factor (CRF), is a polypeptide hormone and neurotransmitter involved in the stress response. CRH and cortisol plasma concentrations were significantly higher in major depression and dysthymia than in the comparison group. The major depressed patients did not show significantly different CRH and cortisol levels than the dysthymic. Severe major depressive disorder exhibited significantly higher CRH plasma levels than the mild or moderate episodes. Plasma cortisol and CRF concentrations correlated significantly.

DA: DA is a neurohormone released by the hypothalamus. Its main function as a hormone is to inhibit the release of prolactin from the anterior lobe of the pituitary. In recent years, there has been a growing interest in the role of DA both in the pathogenesis of unipolar depression and in motivated behavior. Basic scientific and clinical research conducted over the decades that followed confirmed that NE and DA play a critical role in the etiology of depression; though, with the advent of selective serotonin reuptake inhibitor (SSRI) treatments for depression in recent years, this has been largely overshadowed by a focus on serotonin. Plasma DA levels negatively correlate with HAM-D scores in depression (Hamner and Diamond (1996) Psychiatry Res. 64:209-211). In addition, reduced venoarterial plasma concentration of HVA (a metabolite of DA) has been observed in treatment-resistant depression (Lambert et al. (2000) Arch. Gen. Psychiatry 57:787-793). Reduced dopaminergic activity has been associated with anhedonia.

EGF: Among the different factors that may be involved in neuroplasticity, glial cells use growth factor members of the EGF family, acting via receptors endowed with tyrosine kinase activity, to produce morphological changes and release neuroactive substances that directly excite nearby neurons. Agonists of tyrosine-kinase receptors (e.g., NGF, EGF, and basic FGF) enhance Na⁺-dependent serotonin uptake in the synaptosomal-enriched P(2) fraction from rat-brain (Gil et al. (2003) Neurochem. Int. 42:535-542

FABP: The brain is highly enriched in long-chain polyunsaturated fatty acids (PUFAs), which play important roles in brain structural and biologic functions. Plasma transport, in the form of free fatty acids or esterified FAs in lysophosphatidylcholine and lipoproteins, and de novo synthesis contribute to brain accretion of long-chain PUFAs. Docosahexaenoic acid (DHA) is an antidepressant (Mischoulon and Fava (2000) Psychiatr. Clin. North Am. 23:785-94), and FABP has been shown to be elevated in stroke and neurodegenerative diseases (Pelsers and Glatz (2005) Clin. Chem. Lab. Med. 43:802-809; and Zimmermann-Ivol et al. (2004) Mol. Cell. Proteomics 3:66-72.)

Factor VII: Psychological stressors and depressive and anxiety disorders also are associated with coronary artery disease. Changes in blood coagulation, anticoagulant, and fibrinolytic activity may constitute psychobiological pathways that link psychological factors with coronary syndromes (von Kanel et al. (2001) Psychosom. Med. 63:531-544). Levels of Factor VII were found to be lower in subjects with MDD as compared to normal controls. This finding is contrary to some reports of hypercoagulation in depressed patients, particularly those with cardiovascular problems. However, depression has been shown to be associated with inflammation and coagulation factors in cardiovascular disease-free people, suggesting a possible pathway that leads to an increased frequency of events of coronary heart disease in depressive individuals (Panagiotakos (2004) Eur. Heart J. 25:492-499).

GST: Tricyclic antidepressants inhibit the activity of GST isolated from different regions of human brain (e.g., the parietal cortex, frontal cortex, and brain stem). The inhibitory effect depends more on chemical structure than on brain localization of the enzyme. Tricyclics bind nonspecifically to the effector site of GST. The inhibitory effect of tricyclic antidepressants on brain GST may decrease the efficiency of the enzymatic barrier that protects the brain against toxic electrophiles, and may contribute in their adverse effects. On the other hand, brain GST may decrease the therapeutic effects of tricyclic antidepressants by binding them as ligands (Baranczyk-Kuzma et al. (2001) Pol. Merkur Lekarski 11:472-475.)

IL-1: IL-1 is strongly involved in the activation of the HPA axis. Peripheral and central administration of IL-1 also induces NE release in the brain, most markedly in the hypothalamus. Small changes in brain DA are occasionally observed, but these effects are not regionally selective. IL-1 also increases brain concentrations of tryptophan, and the metabolism of serotonin (5-HT) throughout the brain in a regionally nonselective manner. Increases of tryptophan and 5-HT, but not NE, are also elicited by IL-6, which also activates the HPA axis, although it is much less potent in these respects than IL-1.IL-1beta administration to rats stimulated the expression of IL-1beta mRNA in the hypothalamus by 99%, but not that of IL-6. It also significantly activated plasma levels of ACTH, PRL, CORT, and CORT production in adrenal gland. These results indicate that acute peripheral enhancement of IL-1 beta may induce neuroendocrine changes also via the immediate activation of its own expression in the hypothalamus, but not that of IL-6 expression in the hypothalamus was found.

IL-6: IL-6 is an interleukin, a pro-inflammatory cytokine. It is secreted by T cells and macrophages to stimulate immune response to trauma, especially burns or other tissue damage leading to inflammation. In addition several studies have indicated that single time measurements of plasma IL-6, revealed significant elevations in depressed patients. IL-6 appears to be involved in the pathogenesis of depression. A study of IL-6-deficient mice (IL-6(−/−)) were subjected to depression-related tests (learned helplessness, forced swimming, tail suspension, sucrose preference). IL-6(−/−) mice showed reduced despair in the forced swim, and tail suspension test, and enhanced hedonic behavior. Moreover, IL-6(−/−) mice exhibited resistance to helplessness. This resistance may be caused by the lack of IL-6, because stress increased IL-6 expression in wild-type hippocampi.

IL-7: Like IL-10, levels of IL-7 in plasma also were in reduced in depressed male subjects as compared to controls. IL-7 is a hematopoietic cytokine with critical functions in both B- and T-lymphocyte development. IL-7 also exhibits trophic properties in the developing brain. The direct neurotrophic properties of IL-7 combined with the expression of ligand and receptor in developing brain suggest that IL-7 may be a neuronal growth factor of physiological significance during central nervous system ontogeny (Michealson et al. (1996) Dev. Biol. 179:251-263). Adult neurogenesis has been implicated in the etiology and treatment of depression. Elevated stress hormone levels, which are present in some depressed patients and can precipitate the onset of depression, reduce neurogenesis in animal models. Conversely, virtually all antidepressant treatments, including drugs of various classes, electroconvulsive therapy, and behavioral treatments, increase neurogenesis (Drew and Hen (2007) CNS Neural. Disord. Drug Targets 6:205-218).

IL-10: Depression is associated with activation of the inflammatory response system. Evidence suggests that pro-inflammatory and anti-inflammatory cytokine imbalance affects the pathophysiology of major depression. Pro-inflammatory cytokines are mainly mediated by T-helper (Th)-1 cells, and include IL-1β, IL-6, TNF-α, and interferon-γ. Anti-inflammatory cytokines are mediated by Th-2 cells, and include IL-4, IL-5, and IL-10. In humans, antidepressants significantly increase production of IL-10.

IL-13: IL-13 typically acts as an anti-inflammatory cytokine, suggesting that a lower level of IL-13 might increase the dysregulation of the immune system, resulting in increased proinflammatory cytokine activity. Systemic administration of the bacterial endotoxin lipopolysaccharide (LPS) has profound depressive effects on behavior that are mediated by inducible expression of proinflammatory cytokines such as IL-1, IL-6, and tumor necrosis factor-alpha (TNF-alpha) in the brain. When both LPS and IL-13 were co-injected, IL-13 potentiated the depressive effect (Bluthe et al. (2001) Neuroreport 12:3979-3983).

IL-15: IL-15 is a proinflammatory cytokine that is involved in the pathogenesis of inflammatory/autoimmune disease. In addition, IL-15 has been shown to be somatogenic (Kubota et al. (2001) Am. J. Physiol. Regul. Integr. Comp. Physiol. 281:R1004-R1012).

IL-18: Psychological and physical stresses can exacerbate auto-immune and inflammatory diseases. Plasma concentrations of IL-18 are significantly elevated in patients with major depression disorder or panic disorder as compared with normal controls. ACTH stimulates IL-18 expression in human keratinocytes, which provides an insight into the interaction between ACTH and inflammatory mediators. The elevation of plasma IL-18 levels may reflect increased production and release of IL-18 in the central nervous system under stressful settings (Sekiyama (2005) Immunity 22:669-77). Although evaluating IL-18 provided some differentiation of depressed patients from control subjects, this single marker test does not have sufficient diagnostic discrimination power or the robustness to be used in clinical practice.

Leptin: Leptin is a 16 kDa protein hormone that plays a key role in regulating energy intake and energy expenditure, including the regulation (decrease) of appetite and (increase) of metabolism. Unlike many substances, leptin enters the CNS in proportion to its' plasma concentration. Leptin inhibits appetite by activating several neuroendocrine systems, including the HPA cortical axis. Leptin and cholesterol levels were low in patients with major depressive disorder, but high in schizophrenic patients. Others have found negative correlations between BDI scores and serum cholesterol or leptin levels in the patients with MDD.

NE: NE is synthesized from DA by dopamine β-hydroxylase. It is released from the adrenal medulla into the blood as a hormone, and is also a neurotransmitter in the central nervous system and sympathetic nervous system where it is released from noradrenergic neurons. The actions of NE are carried out via the binding to adrenergic receptors. As a stress hormone, NE affects parts of the brain where attention and responding actions are controlled. Along with epinephrine, NE also underlies the fight-or-flight response, directly increasing heart rate, triggering the release of glucose from energy stores, and increasing blood flow to skeletal muscle. Plasma NE may be useful in distinguishing unipolar from bipolar depression, since the NE level is significantly lower in bipolar disease.

NPY: NPY is a 36 amino acid peptide neurotransmitter found in the brain and autonomic nervous system. NPY has been associated with a number of physiologic processes in the brain, including the regulation of energy balance, memory and learning, and epilepsy. The main effect of increased NPY is increased food intake and decreased physical activity. A wealth of data indicates that neuropeptides, e.g., NPY, CRH, somatostatin, tachykinins, and CGRP have roles in affective disorders and alcohol use/abuse. Impaired metabolism of plasma NPY and the reduced plasma NPY in patients with MDD may be involved in the pathogenesis or pathophysiology of MDD (Hashimoto et al. (1996) Neurosci Lett. 216(1):57-60). Thus, as described herein, measuring NYP levels may contribute to the ability to segregate and monitor therapy.

PAI-1: Tissue-type plasminogen activator (tPA) is a highly specific serine proteinase that catalyzes the generation of zymogen plasminogen from the proteinase plasmin. Proteolytic cleavage of proBDNF, a BDNF precursor, to BDNF by plasmin represents a mechanism by which BDNF action is controlled. Furthermore, studies using mice deficient in tPA has demonstrated that tPA is important for the stress reaction, a common precipitating factor for MDD. Serum levels of the PAI-1, the major inhibitor of tPA, have been shown to be higher in women with MDD than in normal controls. See, e.g., Tsai (2006) Med. Hypotheses 66:319-322.

RANTES: Regulated upon Activation, Normal T-cell Expressed, and Secreted (RANTES; also known as CCL5) is an 8 kDa protein classified as a chemotactic cytokine or chemokine. RANTES is chemotactic for T cells, eosinophils and basophils, and plays an active role in recruiting leukocytes into inflammatory sites. The combined effects of RANTES may serve to amplify inflammatory responses within the central nervous system (Luo et al. (2002) Glia 39:19-30).

Serotonin: A range of studies suggest that both bipolar and unipolar depression are associated with a decrease in the functional levels of serotonin (5-HT2) activity. Decreased levels of serotonin has also been implicated in other related forms of depression such as Seasonal Affective disorder (SAD). The utility of assaying for serotonin in blood or serum is minimal, but measuring serotonin levels in platelets and/or cerebral spinal fluid can provide useful data. In a study of depressed psychiatric inpatients and normal controls, platelet serotonin (blood serotonin) content was significantly higher among depressed psychiatric inpatients with a recent case of a mood disorder than among depressed psychiatric inpatients without recent history of mood disorder. Other results suggested that depressed patients with abnormal personality disorder had higher levels of platelet serotonin than patients without personality disorder. In addition to similarities between 5-HT2A serotonin receptors in platelets and brain, levels of serotonin transporter (SERT) in platelet membranes are identical to those found in the CNS. A number of studies have shown a reduction in SERT density in platelets of depressed individuals compared to SERT density in platelets of healthy subjects.

Thyroxine (T₄): T₄ is involved in controlling the rate of metabolic processes in the body and influencing physical development. The thyroid gland and thyroid hormones generally are believed to be important in the pathogenesis of major depression. For example, studies have documented alterations in components of the hypothalamic-pituitary-thyroid (HPT) axis in patients with primary depression. Screening thyroid tests, however, often add little to diagnostic evaluation, and overt thyroid disease is rare among depressed inpatients. The finding that depression can co-exist with autoimmune subclinical thyroiditis suggests that depression may cause alterations in the immune system, or that it could be an autoimmune disorder itself. The outcome of treatment and the course of depression may be related to thyroid status as well. Augmentation of antidepressant therapy with co-administration of thyroid hormones (mainly T₃) is a treatment option for refractory depressed patients.

TIMP-1: Matrix metalloproteinases (MMPs) and the tissue inhibitors of metalloproteinases (TIMPs), whose expression can be controlled by cytokines, play a role in extracellular matrix remodeling in physiological and pathological processes. A positive association between plasma NE levels and MMP-2 protein levels, as well as a negative correlation between plasma cortisol levels and MMP-2 levels, has been observed (Yang et al. (2002) J. Neuroinununol. 133:144-150).

Questions have been raised regarding evaluation of serum markers for assessing neuropsychiatric diseases. For example, studies investigating testosterone levels and mood disorders have shown conflicting results. More often than not, however, problems with the interpretation of data were due to poor study design. In particular, results from a single assay or a group of assays were considered as single assays rather than analyzed using an algorithm. An expanded library of antibodies (e.g., Ridge's highly multiplexed screening technology, with a capacity of about 200 markers) can be extended to samples (e.g., plasma or serum) from well-characterized patients. In further studies, antibodies for proteins of interest (e.g., monoamines and thyroid hormones) can be used to measure levels in body fluids of patients and controls prior to and during treatment. Surfaces and array designs can be developed to be compatible with samples obtained through a minimally invasive method in order to provide the opportunity for sequential sampling. Sera or plasma typically are used, but, as indicated herein, other biological samples also may be useful. For example, specific monoamines can be measured in urine. In addition, depressed patients as a group have been found to excrete greater amounts of catecholamines and metabolites in urine than healthy control subjects. Analytes of interest include, for example, norepinephrine, epinephrine, vanillylmandelic acid (VMA), and 3-methoxy-4-hydroxyphenylglycol (MHPG). Proteomic studies have indicated that urine is a rich source of proteins and peptides that may be differentially expressed in disease states. Markers associated with neuropsychiatric diseases also can be evaluated (e.g., in collaboration with academic laboratories doing mass spectroscopy-based discovery in cerebrospinal fluid from depressed subjects).

In addition to selected analyte (e.g., protein, peptide, or nucleic acid) markers, algorithms can include other measurable parameters useful in the diagnosis of unipolar depression and/or in distinguishing MDD from other mood disorders (e.g., manic-depressive disorder, post-traumatic stress disorder (PTSD), schizophrenia, seasonal affective disorder (SAD), post-partum depression, and chronic fatigue syndrome). For example, a panel of 18 analytes as provided in Table 5 herein, a panel of 13 analytes as provided in Table 13 herein, or a sub-set thereof (e.g., as listed in Tables 6-11 and 14-20 herein), either alone or in combination with other measurable parameters, can be used to distinguish MDD from diseases of the elderly that are associated with depression, including, without limitation, vascular dementia, Alzheimer's disease, chronic pain, and disabilities. Similarly, depression in young people seldom presents as a solitary problem but is commonly part of a complex pattern of behavioral concerns, which can be challenging both for diagnosis and treatment. For example, depressed youth often have at least one other concurrent diagnosis, such as anxiety, substance abuse, and disruptive behavior disorders. Further, depressed youth can develop a bipolar mood disorder over time. Diagnosis in such cases can be aided by measuring the levels of specific analytes and calculating a MDD score as described herein.

In some embodiments, a MDD score can include the additional factoring in of other measurable parameters, such as imaging using computerized tomography (CT) scans, magnetic resonance imaging (MRI), molecular resonance spectrography (MRS), other physical measurements such as body mass index (BMI), and measures of thyroid function (e.g., TSH, free thyroxine (fT₄), free triiodothyronine (fT₃), reverse T₃ (rT₃), anti-thyroglobulin antibodies (anti-TG), anti-thyroid peroxidase antibodies (anti-TPO), fT₄/fT₃, and fT₃/rT₃). For example, to sub-classify and further characterize patients, subjects can be imaged with CT scans or MRS, including phosphorus magnetic resonance spectroscopy (³¹P-MRS). Similar studies have suggested that cerebral metabolic changes are implicated in the pathology of MDD. Experiments using ³¹P-MRS have shown that cerebral energy metabolism (e.g., beta-nucleoside triphosphate (beta-NTP), primarily reflecting brain levels of adenosine triphosphate (ATP)), is lower in depressed subjects than in normal controls, and is positively correlated with severity of depression. Beta-NTP levels also appear to correct after successful antidepressant treatment, but not in treatment of non-responders. ³¹P-MRS methods, including 3D chemical shift imaging, provide the possibility to measure ³¹P-MRS metabolites from specific brain regions.

Further, male-female contrasts in estrogen production throughout the reproductive years are proposed to differentially modulate the expression of depression between genders. Mood changes frequently are reported during the late luteal phase of the menstrual cycle and following childbirth. The finding of increased risk for depression at menopause has not been replicated consistently, but a recent epidemiologic study did find that the onset of major depression was increased after menopause, at a time when estrogen levels decline and post-menopausal women are increasingly vulnerable to depression due to this reduced estrogen production. Similarly, while there is a weak relationship between testosterone and depression in general, there is a much stronger relationship between testosterone and depression that does not respond to treatment.

Thus, in some embodiments, the methods described herein can take advantage of the sensitivity and specificity of custom protein arrays for determination of multiple biomarkers from blood, serum, cerebrospinal fluid, and/or urine. In addition, algorithms can reflect concordance between protein signatures and imaging, as well as psychological testing.

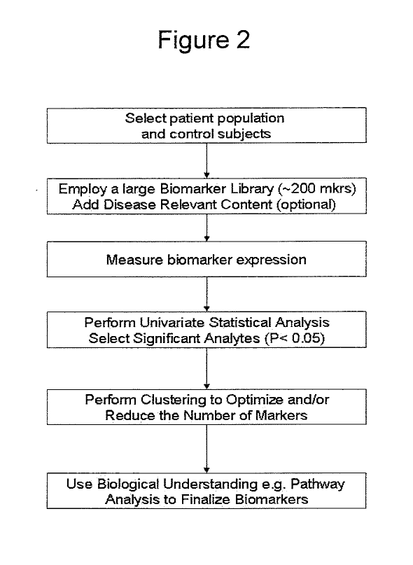

FIG. 2 is a flow diagram detailing the first steps that can be included in development of a disease specific library or panel for use in determining, e.g., diagnosis or prognosis. The process can include two statistical approaches: 1) testing the distribution of biomarkers for association with the disease by univariate analysis; and 2) clustering the biomarkers into groups using a tool that divides the biomarkers into non-overlapping, uni-dimensional clusters, a process similar to principal component analysis. After the initial analysis, a subset of two or more biomarkers from each of the clusters can be identified to design a panel for further analyses. The selection typically is based on the statistical strength of the markers and current biological understanding of the disease.

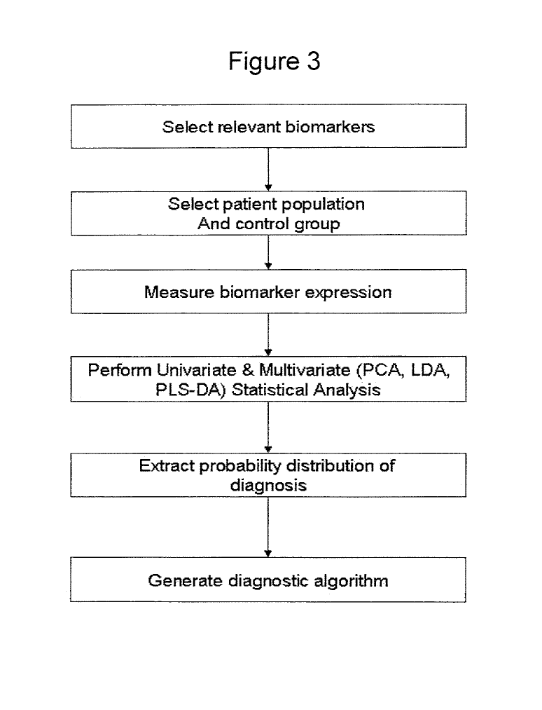

FIG. 3 is a flow diagram depicting steps that can be included to develop a disease specific library or panel for use in establishing diagnosis or prognosis, for example. As shown in FIG. 3, the selection of relevant biomarkers need not be dependent upon the selection process described in FIG. 2, although the first process is efficient and can provide an experimentally and statistically based selection of markers. The process can be initiated, however, by a group of biomarkers selected entirely on the basis of hypothesis and currently available data. The selection of a relevant patient population and appropriately matched (e.g., for age, sex, race, BMI, and/or any other suitable parameters) population of normal subjects typically is involved in the process. In some embodiments, patient diagnoses can be made using state of the art methodology and, in some cases, by a single group of physicians with relevant experience with the patient population. Biomarker expression levels can be measured using Luminex MAP-x, Pierce SEARCHLIGHT, the PHB MIMS instrument or any other suitable technology, including single assays (e.g., ELISA or PCR). Univariate and multivariate analyses can be performed using conventional statistical tools (e.g., not limited to: T-tests, principal components analysis (PCA), linear discriminant analysis (LDA), or Binary Logistic Regression).

### Analyte Measurement

Methods for diagnosing a depression disorder and monitoring a subject's response to treatment for depression as provided herein can include determining the levels of a group of biomarkers in a biological sample collected from the subject. An exemplary subject is a human, but subjects can also include animals that are used as models of human disease (e.g., mice, rats, rabbits, dogs, and non-human primates). The group of biomarkers can be specific to a particular disease. For example, a plurality of analytes can form a panel specific to MDD.

Any appropriate method(s) can be used to quantify the parameters included in a diagnostic/prognostic algorithm. For example, analyte measurements can be obtained using one or more medical devices or clinical evaluation scores to assess a subject's condition, or using tests of biological samples to determine the levels of particular analytes. As used herein, a “biological sample” is a sample that contains cells or cellular material, from which nucleic acids, polypeptides, or other analytes can be obtained. Depending upon the type of analysis being performed, a biological sample can be serum, plasma, or blood cells (e.g., blood cells isolated using standard techniques). Serum and plasma are exemplary biological samples, but other biological samples can be used. Examples of other suitable biological samples include, without limitation, urine, blood, serum, plasma, cerebrospinal fluid, pleural fluid, bronchial lavages, sputum, peritoneal fluid, bladder washings, secretions (e.g., breast secretions), oral washings, swabs (e.g., oral swabs), isolated cells, tissue samples, touch preps, and fine-needle aspirates. In some cases, if a biological sample is to be tested immediately, the sample can be maintained at room temperature; otherwise the sample can be refrigerated or frozen (e.g., at −80° C.) prior to assay.

A number of methods can be used to quantify biomarkers (e.g., analytes). For example, measurements can be obtained using one or more medical devices or clinical evaluation scores to assess a subject's condition, or using tests (e.g., biochemical, biophysical, or traditional clinical chemistry analysis) of biological samples to determine the levels of particular analytes. Measurements can be obtained separately for individual parameters, or can be obtained simultaneously for a plurality of parameters. Any suitable platform can be used to obtain measurements for parameters.

Multiplex methods are particularly useful, as they require smaller sample volumes and perform all of the analysis at one time under the same incubation conditions. Useful platforms for simultaneously quantifying multiple parameters include, for example, those described in U.S. Provisional Application Nos. 60/910,217 and 60/824,471, U.S. Utility application Ser. No. 11/850,550, and PCT Publication No. WO2007/067819, all of which are incorporated herein by reference in their entirety. An example of a useful platform utilizes Molecular Interaction Measurement System (MIMS) label-free assay technology, developed by Ridge Diagnostics, Inc. (Research Triangle Park, NC; formerly Precision Human Biolaboratories, Inc.), which can be used for biomarker quantification without labeling of antigen or antibody. MIMS is nearly reagent free, is rapid, and can be readily used by non-technical individuals. Briefly, local interference at the boundary of a thin film can be the basis for optical detection technologies. For biomolecular interaction analysis, glass chips with an interference layer of SiO2 can be used as a sensor. Molecules binding at the surface of this layer increase the optical thickness of the interference film, which can be determined as set forth in U.S. Provisional Application Nos. 60/910,217 and 60/824,471, for example.

Another example of platform useful for multiplexing is the FDA approved, flow-based Luminex assay system (xMAP; online at luminexcorp.com). This multiplex technology uses flow cytometry to detect antibody/peptide/oligonucleotide or receptor tagged and labeled microspheres. Since the system is open in architecture, Luminex can be readily adapted to host particular disease panels. Other techniques that can be used to quantify biomarkers include BIACORE™ Surface Plasmon Resonance (GE Healthcare, Chalfont St. Giles, United Kingdom) and protein arrays.

Another useful technique for analyte quantification is immunoassay, a biochemical test that measures the concentration of a substance (e.g., in a biological tissue or fluid such as serum, plasma, cerebral spinal fluid, or urine) based on the specific binding of an antibody to its antigen. Antibodies chosen for biomarker quantification must have a high affinity for their antigens. A vast array of different labels and assay strategies has been developed to meet the requirements of quantifying plasma proteins with sensitivity, accuracy, reliability, and convenience. For example, Enzyme Linked ImmunoSorbant Assay (ELISA) can be used to quantify biomarkers a biological sample. In a “solid phase sandwich ELISA,” an unknown amount of a specific “capture” antibody can be affixed to a surface of a multiwell plate, and the sample can be allowed to absorb to the capture antibody. A second specific, labeled antibody then can be washed over the surface so that it can bind to the antigen. The second antibody is linked to an enzyme, and in the final step a substance is added that can be converted by the enzyme to generate a detectable signal (e.g., a fluorescent signal). For fluorescence ELISA, a plate reader can be used to measure the signal produced when light of the appropriate wavelength is shown upon the sample. The quantification of the assays endpoint involves reading the absorbance of the colored solution in different wells on the multiwell plate. A range of plate readers are available that incorporate a spectrophotometer to allow precise measurement of the colored solution. Some automated systems, such as the BIOMEK® 1000 (Beckman Instruments, Inc.; Fullerton, Calif.), also have built-in detection systems. In general, a computer can be used to fit the unknown data points to experimentally derived concentration curves.

A number of other higher throughput, multiplexed technologies also can be used to rapidly measure and validate disease-specific and compound-specific biomarkers. These include immunobead based assays, chemoluminescent multiplex assays, and chip and protein arrays. Various protein array substrates can be used, including nylon membranes, plastic microwells, planar glass slides, gel-based arrays, and beads in suspension arrays. In addition to immunoassay-based methodology, high throughput mass spectroscopy-based technologies can be used to both establish the identity and quantify peptides and proteins. The ability of mass spectroscopy to quantify specific protein patterns associated with certain biological conditions within a complex background in an absolute quantitative way can facilitate data standardization, which can be essential for comparing biomarker expression as well as for computational biology and biosimulation.

In some embodiments, a diagnosis of MDD, stratification of MDD severity, and/or treatment monitoring for MDD can be made based on the level of a single analyte. For example, apolipoprotein CIII levels can be measured in a biological sample from a subject and the level can be compared to a control level of apolipoprotein CIII. If the level measured in the subject is greater than the control level (e.g., 5%, 10%, 20%, 25%, 50%, 75%, 100%, or more than 100% greater than the control level), the subject can be classified as having, or being likely to have, MDD. If the level measured in the subject is not greater than the control level, the subject can be classified as not having, or not being likely to have, MDD. The severity of MDD also can be stratified based on the level of a single analyte in the subject, and MDD treatment can be monitored in the subject based on changes in the levels of one or more single analytes. For example, a diagnosis of MDD, stratification of MDD severity, or treatment monitoring for MDD can be made based on the measured level of a single analyte such as epidermal growth factor, prolactin, resistin, or apolipoprotein CIII, or combinations of two, three, or all of those four analytes. It is to be noted that, as for diagnostic scores, a health care or research professional can take one or more actions that can affect patient care based on the measured level of a single analyte (e.g., epidermal growth factor, prolactin, resistin, or apolipoprotein CIII).

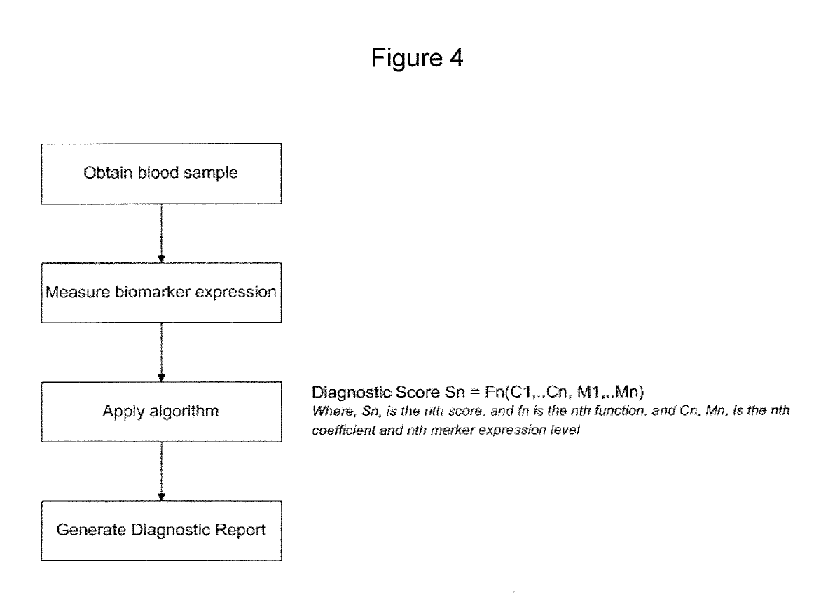

FIG. 4 is a flow diagram depicting steps that can be included in establishing set scores for diagnostic development and application. The process can involve obtaining a biological sample (e.g., a blood sample) from a subject to be tested. Depending upon the type of analysis being performed, serum, plasma, or blood cells can be isolated by standard techniques. If the biological sample is to be tested immediately, the sample can be maintained at room temperature; otherwise the sample can be refrigerated or frozen (e.g., at −80° C.) prior to assay. Biomarker expression levels can be measured using a MIMS instrument or any other suitable technology, including single assays such as ELISA or PCR, for example. Data for each marker can be collected, and an algorithm can be applied to generate a set diagnostic scores. The diagnostic scores, as well as the individual analyte levels, can be provided to a clinician for use in establishing a diagnosis and/or a treatment action for the subject.

### Methods for Using Diagnostic Scores

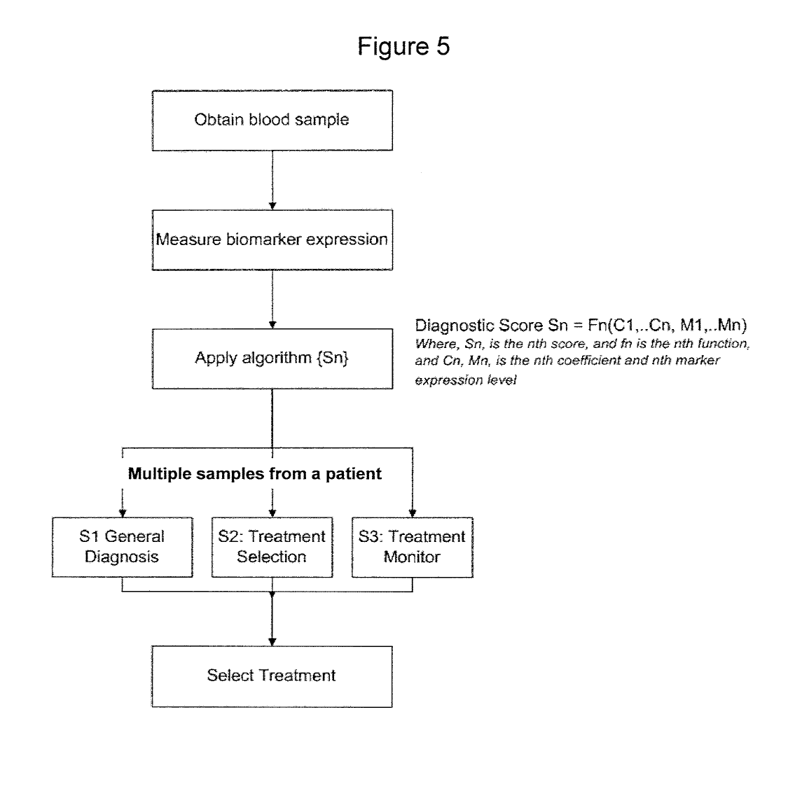

FIG. 5 is a flow diagram illustrating an exemplary process for using diagnostic scores to aid in determining diagnoses, selecting treatments, and monitoring treatment progress. As depicted in FIG. 5, one or more multiple diagnostic scores can be generated using the expression levels of a set of biomarkers. In this example, multiple biomarkers can be measured in a subject's blood sample, and three diagnostic scores are generated by the algorithm. In some cases, a single diagnostic score can be sufficient to aid in diagnosis, treatment selection, and monitoring treatment. When a treatment is selected and treatment begins, the patient can be monitored periodically by measuring biomarker levels (e.g., in a subsequently drawn blood sample), and generating and comparing diagnostic scores.

Nearly half of medical outpatients who receive an antidepressant prescription discontinue treatment during the first month. Patient follow-up and monitoring therefore are extremely important during the first month of treatment. Discontinuation rates within the first three months can reach nearly 70%, depending on the population studied and the agent used (Keller et al. Tnt. Clin. Psychopharmacol. (2002) 17:265-271). Adverse effects of antidepressants are major contributors to treatment failure, as is the perception of lack of efficacy. Thus, MDD scores can be used to monitor patient status during treatment and to adjust treatment, for example. Multiple measurements can be used to develop S3. These multiple scores can be used to continually adjust the treatment (dose and schedule) and to periodically assess the patient's status, optimize and select new single or multiple agent therapeutics.

An example of platform useful for multiplexing is the FDA approved flow-based Luminex assay system (xMAP; World Wide Web at luminexcorp.com). This multiplex technology uses flow cytometry to detect antibody/peptide/oligonucleotide or receptor tagged and labeled microspheres. Since the system is open in architecture, Luminex can be readily adapted to host particular disease panels.

Diagnostic scores generated by the methods provided herein can be used to monitor treatment. For example, diagnostic scores and/or individual analyte levels or biomarker values can be provided to a clinician for use in establishing or altering a course of treatment for a subject. When a treatment is selected and treatment begins, the subject can be monitored periodically by collecting biological samples at two or more intervals, measuring biomarker levels to generate a diagnostic score corresponding to a given time interval, and comparing diagnostic scores over time. On the basis of these scores and any trends observed with respect to increasing, decreasing, or stabilizing diagnostic scores, a clinician, therapist, or other health-care professional may choose to continue treatment as is, to discontinue treatment, or to adjust the treatment plan with the goal of seeing improvement over time. For example, a decrease in disease severity as determined by a change in diagnostic score (e.g., toward a control score for normal individuals not having MDD) can correspond to a patient's positive response to treatment. An increase in disease severity as determined by a change in diagnostic score (e.g., away from a control score for normal individuals not having MDD), or no change in diagnostic score from a baseline level, can indicate failure to respond positively to treatment and/or the need to reevaluate the current treatment plan. A static diagnostic score can correspond to stasis with respect to disease severity.

Diagnostic scores also can be used to stratify disease severity. In some cases, individual analyte levels and/or diagnostic scores determined by the algorithms provided herein can be provided to a clinician for use in diagnosing a subject as having mild, moderate, or severe depression. For example, diagnostic scores generated using the algorithms provided herein can be communicated by research technicians or other professionals who determine the diagnostic scores to clinicians, therapists, or other health-care professionals who will classify a subject as having a particular disease severity based on the particular score, or an increase or decrease in diagnostic score over a period of time. On the basis of these classifications, clinicians, therapists, or other health-care professionals can evaluate and recommend appropriate treatment options, educational programs, and/or other therapies with the goal of optimizing patient care. Diagnoses can be made, for example, using state of the art methodology, or can be made by a single physician or group of physicians with relevant experience with the patient population. When a patient is being monitored after treatment, movement between disease strata (i.e., mild, moderate, and severe depression) can indicate increasing or decreasing disease severity. In some cases, movement between disease strata can correspond to efficacy of the treatment plan selected for a particular subject or group of subjects.

After a patient's diagnostic scores are reported, a health-care professional can take one or more actions that can affect patient care. For example, a health-care professional can record the diagnostic score in a patient's medical record. In some cases, a health-care professional can record a diagnosis of MDD, or otherwise transform the patient's medical record, to reflect the patient's medical condition. In some cases, a health-care professional can review and evaluate a patient's medical record, and can assess multiple treatment strategies for clinical intervention of a patient's condition.

A health-care professional can initiate or modify treatment for MDD symptoms after receiving information regarding a patient's diagnostic score. In some cases, previous reports of diagnostic scores and/or individual analyte levels can be compared with recently communicated diagnostic scores and/or disease states. On the basis of such comparison, a health-care profession may recommend a change in therapy. In some cases, a health-care professional can enroll a patient in a clinical trial for novel therapeutic intervention of MDD symptoms. In some cases, a health-care professional can elect waiting to begin therapy until the patient's symptoms require clinical intervention.

A health-care professional can communicate diagnostic scores and/or individual analyte levels to a patient or a patient's family. In some cases, a health-care professional can provide a patient and/or a patient's family with information regarding MDD, including treatment options, prognosis, and referrals to specialists, e.g., neurologists and/or counselors. In some cases, a health-care professional can provide a copy of a patient's medical records to communicate diagnostic scores and/or disease states to a specialist.

A research professional can apply information regarding a subject's diagnostic scores and/or disease states to advance MDD research. For example, a researcher can compile data on MDD diagnostic scores with information regarding the efficacy of a drug for treatment of MDD symptoms to identify an effective treatment. In some cases, a research professional can obtain a subject's diagnostic scores and/or individual analyte levels to evaluate a subject's enrollment or continued participation in a research study or clinical trial. A research professional can classify the severity of a subject's condition based on the subject's current or previous diagnostic scores. In some cases, a research professional can communicate a subject's diagnostic scores and/or individual analyte levels to a health-care professional, and/or can refer a subject to a health-care professional for clinical assessment of MDD and treatment of MDD symptoms.

Any appropriate method can be used to communicate information to another person (e.g., a professional), and information can be communicated directly or indirectly. For example, a laboratory technician can input diagnostic scores and/or individual analyte levels into a computer-based record. In some cases, information can be communicated by making a physical alteration to medical or research records. For example, a medical professional can make a permanent notation or flag a medical record for communicating a diagnosis to other health-care professionals reviewing the record. Any type of communication can be used (e.g., mail, e-mail, telephone, facsimile and face-to-face interactions). Secure types of communication (e.g., facsimile, mail, and face-to-face interactions) can be particularly useful. Information also can be communicated to a professional by making that information electronically available (e.g., in a secure manner) to the professional. For example, information can be placed on a computer database such that a health-care professional can access the information. In addition, information can be communicated to a hospital, clinic, or research facility serving as an agent for the professional. The Health Insurance Portability and Accountability Act (HIPAA) requires information systems housing patient health information to be protected from intrusion. Thus, information transferred over open networks (e.g., the internet or e-mail) can be encrypted. When closed systems or networks are used, existing access controls can be sufficient.

### Biomarker Hypermapping

In some embodiments, the methods provided herein can include the use of biomarker hypermapping (BHM) technology, which represents a methodology to both visualize patterns associated with the disease state as well as sub-classification of patient groups or individual patients based upon a pattern.

Commonly, methods related to multi-analyte diagnostics typically use either a global optimization method in which all the markers (parameters) are used in multivariable optimization to best fit the clinical study results, or use a decision tree methodology. Decision trees can be used to determine the best way to distinguish individuals with a disease from normal subjects in a clinical setting. Many of these methods are effective when the number of analyzes are small (typically less than 5). In such situations, experts as well as those less skilled can make a diagnosis independent of significant insight into the underlying biology of the disease or the tests employed. For complex diseases, however, where symptoms overlap and there can be significant variation between stages of disease, a larger number of analytes are required to diagnose or sub-classify patients. In such cases, many parameters need to be taken into account, and the contribution of each parameter (analyte) is small. Even experts can have a hard time gaining insight into the status of an individual patient. Similarly, medical researchers looking at the underlying biology of a disease or hoping to develop new therapeutics may miss useful information by performing a simple global optimization.

The BMH approach uses biomarkers reflective of different physiologic parameters (e.g., hormones, metabolic markers, and inflammatory markers) to construct a visualization of changes in biomarker expression that may be related to disease state. In this process, a patient's biomarker responses are mapped onto a multi-dimensional hyperspace. Distinct coefficients can be derived to create hyperspace vectors for subsets of patients and age-matched normal subjects. Multiplex biomarker data from clinical sample sets can be used iteratively to construct and define a hyperspace map, which then can be used to separate disease states from normal states and provide guidance in treatment plans.

In general, the methods described herein are directed to analysis of multi-analyte diagnostic tests. These methods can be particular useful with complex diseases, for which it often is difficult to identify one or two markers that will provide enough unique separation between patient sub-groups, e.g., those with a different prognosis or manifestation of disease or, as often occurs with behavioral diseases, distinguishing affected from normal subjects. Multiple markers (e.g., 2, 3, 4, 5, or more than 5 markers) can be used in combination in the presently described methods to provide increased power of a diagnostic test, allowing clinicians to discriminate between patients and prevent confounding co-morbidities from other diseases from interfering with sensitivity and specificity, for example.

Different groups of markers can be selected based on physiologic/biologic functions related to a disease of interest by use of direct analysis of clinical studies and/or bioinformatics. Using a large library of biomarkers, markers can be grouped according to functional activity that reflects different segments of human physiology and/or biologic processes. Within each group, multiple markers can be used to provide an accurate measurement of the physiologic or biologic changes within each process or system. For analysis of complex diseases, multiple groups can be used for measurement of whole body changes under a particular disease condition.

Rather than performing a global optimization for all measured markers in all related groups within a body of clinical study data, the methods provided herein can first include optimization of the measured markers in each functional group using clinical study data. The optimized results for each group can be used to construct a combination parameter that represents the group in the construction of a preliminary hypermap of the disease. Data from multiple studies can be used iteratively to further develop the disease hypermap. The data from individual patients then can be mapped to the disease hypermap in order to take advantage of what is known about previously characterized patients whose biomarker profiles fall within the same multi-dimensional space. Knowledge gained from analysis of previously characterized patients can be used to sub-categorize the patient, predict disease course, and make decisions regarding, for example, treatment options (e.g., drugs of choice and other potentially successful therapeutic approaches).

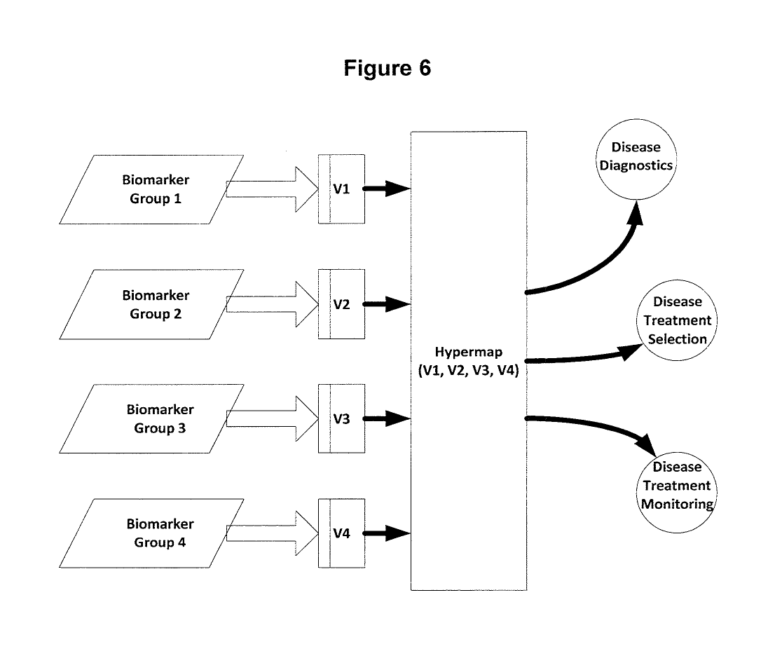

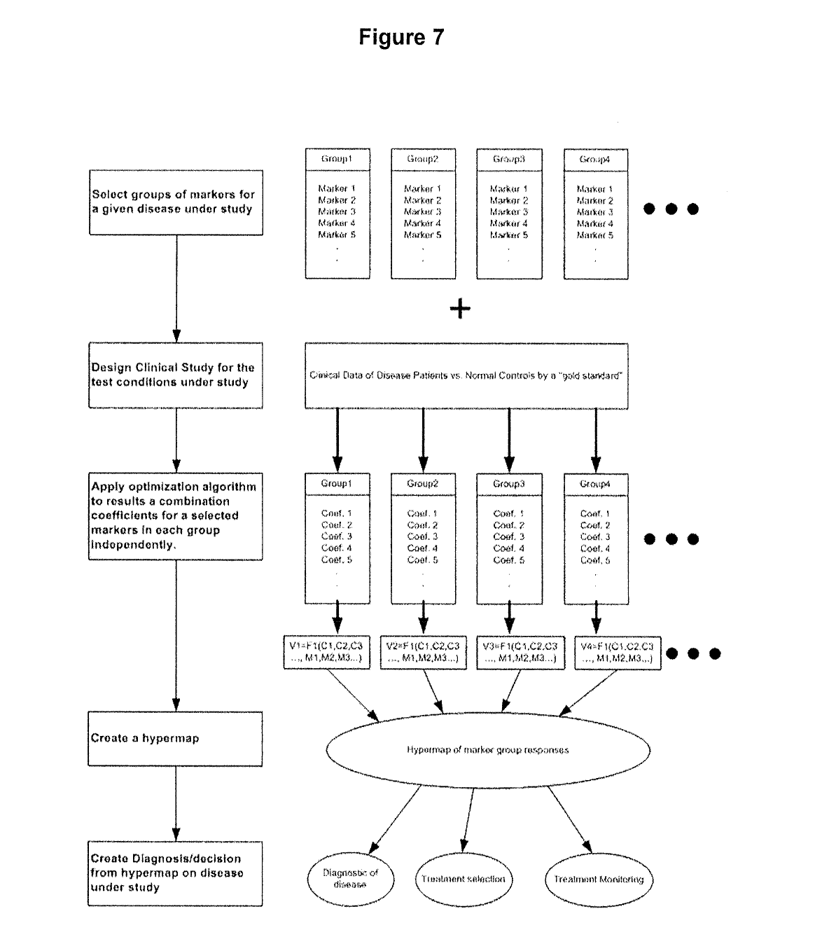

FIGS. 6 and 7 illustrate processes for constructing hypermaps from selected groups, markers, and clinical data for a given disease. As shown, several steps can be used to create a hypermap for a disease of interest. In some embodiments, the first step can be to select groups of markers, based on the physiology and biology of the disease, as well as current understanding of biomarker responses within the disease state. Many diseases have shared elements that include inflammation, tissue remodeling, metabolic changes, immune response, cell migration, hormonal imbalance, etc. Certain diseases are associated with pain or neurologic dysfunction, or there may be specific markers that are characteristic of a specific disease (e.g., elevated blood glucose in diabetes) or response to a specific drug (e.g., estrogen receptor expression in breast cancer patients). Biomarkers can be grouped differently, essentially via functional clustering, which can provide more information relative to the pathways involved in physiological dysfunctions. In inflammation, for example, markers can include those related to the acute phase response (e.g., C-reactive protein), the cytokine response (e.g., Th1- and Th2-related interleukins), chemokines, and chemoattractant molecules (e.g., IL-8 in the attraction of neurophils into the lung that is characteristic of certain respiratory diseases).

### Methods for Using Hypermapping Information

Information regarding biomarkers and hypermapping as discussed herein can be used for, without limitation, treatment monitoring. For example, hypermapping information can be provided to a clinician for use in establishing or altering a course of treatment for a subject. When a treatment is selected and treatment starts, the subject can be monitored periodically by collecting biological samples at two or more intervals, generating hypermapping information corresponding to a given time interval pre- and post-treatment, and comparing the result of hypermaps over time. On the basis of such hypermapping information and any trends observed with respect to increasing, decreasing, or stabilizing biomarker levels, for example, a clinician, therapist, or other health-care professional may choose to continue treatment as is, to discontinue treatment, or to adjust the treatment plan with the goal of seeing improvement over time.

After a patient's biomarker and/or hypemapping information is reported, a health-care professional can take one or more actions that can affect patient care. For example, a health-care professional can record the information and biomarker expression levels in a patient's medical record. In some cases, a health-care professional can record a diagnosis of a neuropsychiatric disease, or otherwise transform the patient's medical record, to reflect the patient's medical condition. In some cases, a health-care professional can review and evaluate a patient's medical record, and can assess multiple treatment strategies for clinical intervention of a patient's condition.

For major depressive disorder and other mood disorders, treatment monitoring can help a clinician adjust treatment dose(s) and duration. An indication of a subset of alterations in hypermapping information that more closely resemble normal homeostasis can assist a clinician in assessing the efficacy of a regimen. A health-care professional can initiate or modify treatment for symptoms of depression and other neuropsychiatric diseases after receiving information regarding a patient's hypermapping result. In some cases, previous reports of hypermapping information can be compared with recently communicated hypermapping information. On the basis of such comparison, a health-care profession may recommend a change in therapy. In some cases, a health-care professional can enroll a patient in a clinical trial for novel therapeutic intervention of MDD symptoms. In some cases, a health-care professional can elect waiting to begin therapy until the patient's symptoms require clinical intervention.

A health-care professional can communicate information regarding or derived from hypermapping to a patient or a patient's family. In some cases, a health-care professional can provide a patient and/or a patient's family with inform ation regarding MDD, including treatment options, prognosis, and referrals to specialists, e.g., neurologists and/or counselors. In some cases, a health-care professional can provide a copy of a patient's medical records to communicate hypermapping information to a specialist.

A research professional can apply information regarding a subject's hypermapping information to advance MDD research. For example, a researcher can compile data on hypermaps with information regarding the efficacy of a drug for treatment of depression symptoms, or the symptoms of other neuropsychiatric diseases, to identify an effective treatment. In some cases, a research professional can obtain a subject's hypermapping information to evaluate a subject's enrollment or continued participation in a research study or clinical trial. In some cases, a research professional can communicate a subject's hypermapping information to a health-care professional, and/or can refer a subject to a health-care professional for clinical assessment and treatment of neuropsychiatric disease.

Any appropriate method can be used to communicate information to another person (e.g., a professional), and information can be communicated directly or indirectly. For example, a laboratory technician can input vector information, biomarker levels, and/or hypermapping outcome information into a computer-based record. In some cases, information can be communicated by making a physical alteration to medical or research records. For example, a medical professional can make a permanent notation or flag a medical record for communicating a diagnosis to other health-care professionals reviewing the record. Any type of communication can be used (e.g., mail, e-mail, telephone, facsimile and face-to-face interactions). Secure types of communication (e.g., facsimile, mail, and face-to-face interactions) can be particularly useful. Information also can be communicated to a professional by making that information electronically available (e.g., in a secure manner) to the professional. For example, information can be placed on a computer database such that a health-care professional can access the information. In addition, information can be communicated to a hospital, clinic, or research facility serving as an agent for the professional. Information transferred over open networks (e.g., the internet or e-mail) can be encrypted. When closed systems or networks are used, existing access controls may be sufficient.

### Computer-Based Systems

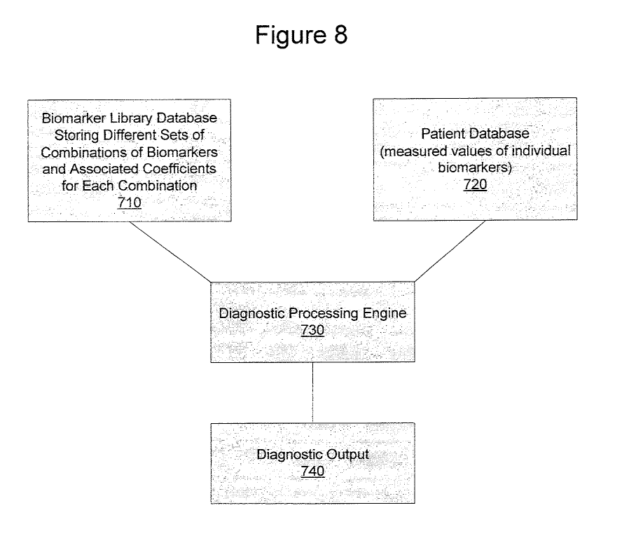

FIG. 8 shows an example of a computer-based diagnostic system employing the biomarker analysis described above. This system includes a biomarker library database 710 that stores different sets combinations of biomarkers and associated coefficients for each combination based on biomarker algorithms which are generated based on, e.g., the method shown in FIG. 2 or 3. The database 710 is stored in a digital storage device in the system. A patient database 720 is provided in this system to store measured values of individual biomarkers of one or more patients under analysis. A diagnostic processing engine 730, which can be implemented by one or more computer processors, is provided to apply one or more sets of combinations of biomarkers in the biomarker library database 710 to the patient data of a particular patient stored in the database 720 to generate diagnostic output for a set of combination of biomarkers that is selected for diagnosing the patient. Two or more such sets may be applied to the patient data to provide two or more different diagnostic output results. The output of the processing engine 730 can be stored in an output device 740, which can be, e.g., a display device, a printer, or a database.

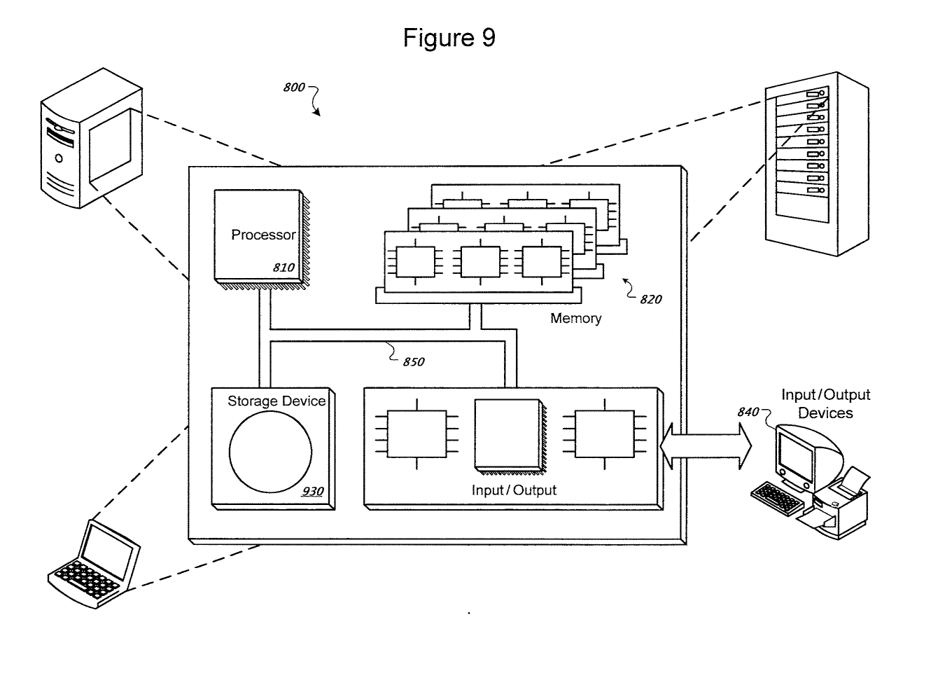

One or more computer systems can be used to implement the system in FIG. 8 and for the operations described in association with any of the computer-implement methods described in this document. FIG. 9 shows an example of such a computer system 800. The system 800 can include various forms of digital computers, such as laptops, desktops, workstations, personal digital assistants, servers, blade servers, mainframes, and other appropriate computers. The system 800 can also include mobile devices, such as personal digital assistants, cellular telephones, smartphones, and other similar computing devices. Additionally the system can include portable storage media, such as, Universal Serial BUS (USB) flash drives. For example, the USB flash drives may store operating systems and other applications. The USB flash drives can include input/output components, such as a wireless transmitter or USB connector that may be inserted into a USB port of another computing device.

In the specific example in FIG. 9, the system 800 includes a processor 810, a memory 820, a storage device 830, and an input/output device 840. Each of the components 810, 820, 830, and 840 are interconnected using a system bus 850. The processor 810 is capable of processing instructions for execution within the system 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device.

The input/output device 840 provides input/output operations for the system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

The invention will be further described in the following examples, which do not limit the scope of the invention described in the claims.

### EXAMPLES

### Example 1

### Diagnostic Markers of Depression

Methods provided herein were used to develop an algorithm for determining depression scores that are useful to diagnose or determine predisposition to MDD, and to evaluate a subject's response to anti-depressive therapeutics. Multiplexed detection systems were used to phenotype molecular correlates of depression. Three statistical approaches were used for biomarker assessment and algorithm development: (1) univariate analysis for testing the distribution of biomarkers for association with MDD; and (2) linear discriminant analysis (LDA) and (3) binary logistic regression for algorithm construction.

Univariate Analysis of Individual Analyte Levels:

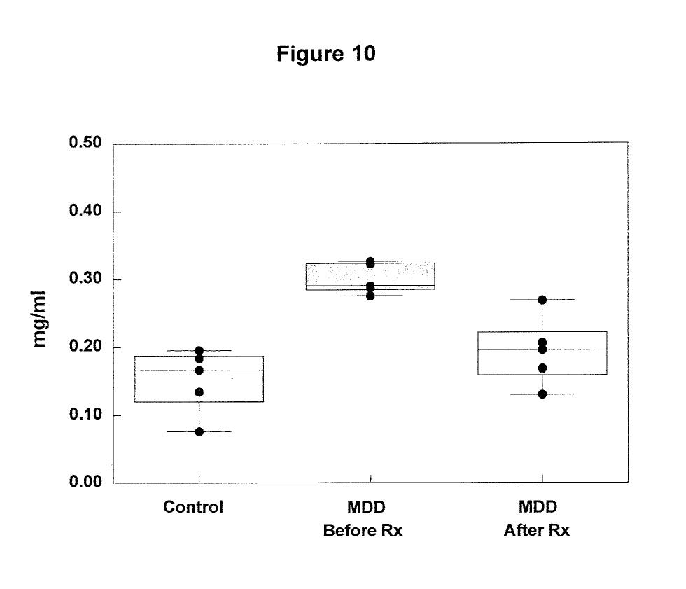

Using the Student's T-test, serum levels of each of the analytes were tested using Luminex multiplex technology and we compared depressed versus normal subjects. The level of significance was set at α≦0.05. Univariate analysis separately explores each variable in a data set. This method looks at the range of values and the central tendency of the values, describes the pattern of response to the variable, and describes each variable on its own. By way of example, FIG. 10 shows the distribution of blood levels for marker X in a hypothetical series of six MDD patients before and after treatment. The first point to be made from this graph is that the concentration of marker X was higher in untreated MDD patients as opposed to control subjects. Second, the levels of marker X in the MDD patients after treatment was similar to that of the control.

The Student's t-Test was then used to compare the two sets of data and to test the hypothesis that a difference in their means is significant. The difference in the means is of statistical significance on the basis of how many standard deviations separate the means. The distance between means is judged significant using Student's t-statistic and its corresponding probability or significance that the absolute value of the t-statistic could be this large or larger by chance. In addition, the t-Test takes into account whether the populations are independent or paired. An independent t-Test can be used when two groups are thought to have the same overall variance but different means. This test can provide support for a statement about how a given population varies from an ideal measure, such as how a treated group compares with an independent control group. The independent t-Test can be performed on data sets with an unequal number of points. In contrast, the paired test is used only when two samples are of equivalent size (i.e., include same number of points). This test assumes that the variance for any point in one population is the same for the equivalent point in the second population. This test can be used to support conclusions about a treatment by comparing experimental results on a sample-by-sample basis. For example, a paired t-Test can be used to compare results for a single group before and after a treatment. This approach can help to evaluate two data sets whose means do not appear to be significantly different using the independent t-Test. During the test(s), the Student's t-Statistic for measuring the significance of the difference between the means is calculated, and the probability (p-Value) that the t-Statistic takes on its value by chance. The smaller the p-Value, the more significant the difference in the means. For many biological systems, an alpha level (or level of significance) of p>0.05 represents the probability that the t-Statistic is achievable just by chance.

For example, application of the student's t-Test to the data in FIG. 10 (where there are equal numbers of points in each group) showed that the difference in marker X expression between control subjects and patients with MDD was statistically significant at p>0.002, and the difference in the MDD patients pre- and post-treatment was significant with p>0.013. In contrast, there was no statistically significant difference between the control group and the MDD patients after treatment (p>0.35).

Such data is used to obtain a frequency distribution for the variable. This is achieved by all the values of the variable in order from lowest to highest. The number of appearances for each value of the variable is a count of the frequency with which each value occurs in the data set. By way of example, if a MDD score is calculated using an algorithm as described herein, the patient population can be separated into groups having the same MDD score. If patients are monitored before and after treatment, the frequency for each MDD score can be established, and the effectiveness of the treatment can be ascertained.

PCA and PLS-DA:

PCA is mathematically defined as an orthogonal linear transformation that transforms the data to a new coordinate system such that the greatest variance by any projection of the data comes to lie on the first coordinate (called the first principal component), the second greatest variance on the second coordinate, and so on. PCA is used for dimensionality reduction in a data set by retaining those characteristics of the data set that contribute most to its variance, by keeping lower-order principal components and ignoring higher-order ones. Such low-order components often contain the “most important” aspects of the data.

PLS-DA was performed in order to sharpen the separation between groups of observations by rotating PCA components such that a maximum separation among classes was obtained, providing information as to which variables carry the class separating information. PLS-DA and other techniques were used to demonstrate the segregation of normal subjects and depressed patients using the MDD panel to measure serum levels of 16 analytes, all 18 analytes, or sub-sets of four to nine analytes, as examples.

Algorithm Based on Linear Discriminant Analysis (LDA):

To identify the analytes that contribute the most to discrimination between classes (e.g., depressed vs. normal), a stepwise method of LDA from SPSS 11.0 for Windows was used with following settings: Wilks' lambda (Λ) method was used to select analytes that maximize the cluster separation and analyte entrance into the model was controlled by its F-value. A large F-value indicates that the level of the particular analyte is different between the two groups, and a small F-value (F<1) indicates that there is no difference. In this method, the null hypothesis is rejected for small values of Λ. Thus, the aim was to minimize Λ.

To construct a list of analyte predictors, the F-values for each of the analytes was calculated. Starting with the analyte having the largest F-value (the analyte that differs the most between the two groups), the value of Λ was determined. The analyte with the next largest F-value was then added to the list and Λ was recalculated. If the addition of the second analyte lowered the value of Λ, it was kept in the list of analyte predictors. The process of adding analytes one at a time was repeated until the reduction of Λ no longer occurred.

Cross-validation, a method for testing the robustness of a prediction model, was then carried out. To cross-validate a prediction model, one sample was removed and set aside, the remaining samples were used to build a prediction model based on the pre-selected analyte predictors, and a determination was made as to whether the new model was able to predict the one sample not used in building the new model correctly. This process was repeated for all samples one at a time, and a cumulative cross-validation rate was calculated. The final list of analyte predictors was determined by manually entering and removing analytes to maximize the cross-validation rate, using information obtained from the univariate analyses and cross-validations. The final analyte classifier was then defined as the set of analyte predictors that gives the highest cross-validation rate.

### Example 2

### Choosing Multiple Biomarkers for MDD

Using the Student's t-Test, serum levels of about 100 analytes were tested using Luminex multiplex technology. The data were subsequently analyzed for a comparison of depressed versus normal subjects. The level of significance was set at α≦0.05. After the initial study, the analytes listed in Table 5 were chosen based on statistical significance. This was followed by multivariate analysis (PCA, PLS-DA, LDA) to identify markers that are useful to distinguish MDD patients from normal populations.

Table 5 lists 18 biomarkers and indicates the nature of their potential relationship of each analyte to the pathophysiology of unipolar depression.

TABLE 5

| Analyte | Relationship to Depression |
|---|---|
| IL-13 | IL-13 usually acts as an anti-inflammatory cytokine |
| IL-7 | IL-7 may be a neuronal growth factor |
| GST | stress related; tricyclics reduce level |
| IL-18 | stress related release of IL-18 in CNS and plasma |
| A2M | acute phase protein associated with inflammatory disease |
| IL-15 | IL-15 is a novel proinflammatory cytokine |
| IL-10 | IL-10 usually acts as an anti-inflammatory cytokine |
| Factor | one of the central proteins in the coagulation cascade. |
| VII | |
| EGF | growth factor involved in neuroplasticity & the EGF-R |
| | TK cascade |
| FABP | FABPs control intracellular transport and storage of lipids |
| PAI-1 | tPA/plasminogen system may play a role in MDD |
| | pathogenesis |
| BDNF | neuroplasticity, lower in MDD, responds to treatment |
| RANTES | RANTES may serve to amplify inflammatory responses |
| | in CNS |
| TIMP-1 | extracellular matrix remodeling in physiological and |
| | pathological processes |
| A1AT | reduced activity of peptidases can occur in MDD |
| B2M | can be associated with chronic inflammatory conditions |
| Cortisol | a stress hormone that can be elevated in MDD |
| Thyroxine | serum T₄ is important for the action of thyroid hormones |
| (T₄) | in the brain |

The potential relevance of each marker to MDD is discussed in further detail herein.

### Example 3

### Use of an Algorithm to Calculate MDD Scores and Assess Treatment

Using 16 of the markers listed in Table 5, as well as ACTH, a diagnostic score was established based on the following algorithm:

$$Depression diagnosis score = f ( a 1 * analyte 1 + a 2 * analyte 2 + a 3 * analyte 3 + a 4 * analyte 4 + a 5 * analyte 5 + a 6 * analyte 6 + a 7 * analyte 7 + a 8 * analyte 8 + a 9 * analyte 9 + a 10 * analyte 10 + a 11 * analyte 11 + a 12 * analyte 12 + a 13 * analyte 13 + a 14 * analyte 14 + a 15 * analyte 15 + a 16 * analyte 16 + a 17 * ACTH ) .$$

Using this algorithm, a depression score was assigned to each subject.

Using five of the markers listed in Table 5 (A2M, BDNF, IL-10, IL-13, and IL-18), a statistically sound diagnostic score was established based on the following algorithm:

Depression diagnosis score=f(a1*A2M+a2*BDNF+a3*IL-10+a4*IL-13+a5*IL-18)

In practical use, a smaller group of biomarkers may be sufficient to aid in diagnosis and treatment monitoring for MDD, either with or without additional information derived from a clinical evaluation. Several others examples using different marker sets were established and are shown in Tables 6-11. The MDD algorithms with sub-sets of four to nine analytes showed diagnostic sensitivity in the range of 70% to 90%. These groups, or combinations of these groups with other information, also are used to distinguish different subtypes of unipolar depression, stratify patients, and/or to select and monitor treatments.

TABLE 6
A seven member sub-set of biomarkers derived from the 18 member panel
Analyte

IL-10
IL-13
IL-18
A2M
BDNF
Thyroxine
cortisol

TABLE 7
A five member sub-set of biomarkers derived from the 18 member panel
Analyte

IL-7
IL-13
IL-18
A2M
BDNF

TABLE 8
A nine member sub-set of biomarkers derived from the 18 member panel
Analyte

IL-13
IL-7
GST
IL-18
A2M
IL-15
IL-10
Cortisol
Thyroxine (T₄)

TABLE 9
A six member sub-set of biomarkers derived from the 18 member panel
Analyte

IL-13
IL-7
GST
IL-18
A2M
IL-15

TABLE 10
An eight member sub-set of biomarkers derived from the 18 member panel
Analyte

IL-13
IL-7
GST
IL-18
A2M
IL-15
IL-10
Cortisol

TABLE 11
A four member sub-set of biomarkers derived from the 18 member panel
Analyte

IL-7
IL-10
A2M
IL-18

Table 12 presents an example of data for subjects for which hypothetical MDD scores were established at baseline (pre-treatment) and post-treatment. Data collected before and after treatment are used to determine the frequency of each MDD score and ascertain whether a particular treatment plan is effective. As shown, the number of patients with low MDD scores (1 and 2) increased from 6 to 11 after treatment, with a concomitant decrease in the higher range of MDD scores (4 and 5) from 13 to 7. These data are indicative of treatment efficacy and demonstrate the utility of MDD diagnostic scores for patient stratification and treatment monitoring.

TABLE 12

| MDD Score | # Pts before Rx | # Pts after Rx |
|---|---|---|
| 1 | 2 | 5 |
| 2 | 4 | 6 |
| 3 | 6 | 7 |
| 4 | 9 | 6 |
| 5 | 4 | 1 |

### Example 4

### Use of HPA Axis Algorithms to Calculate MDD Scores

Table 13 lists a group of biomarkers, including HPA axis biomarkers, and the potential relationship of each analyte to the pathophysiology of MDD. Tables 14-20 list smaller groups of biomarker combinations that also can be used to generate diagnostic scores. These groups or combinations of these groups may be used to diagnose different sub-types of depression disorder, or to select and monitor treatments. In addition, IL-1alpha also can be a useful biomarker for diagnosing and assessing depression.

Using the 13 markers listed in Table 13, as well as NPY, a diagnostic score was established based on the following algorithm:

$$Depression diagnosis score = f ( a 1 * analyte 1 + a 2 * analyte 2 + a 3 * analyte 3 + a 4 * analyte 4 + a 5 * analyte 5 + a 6 * analyte 6 + a 7 * analyte 7 + a 8 * analyte 8 + a 9 * analyte 9 + a 10 * analyte 10 + a 11 * analyte 11 + a 12 * analyte 12 + a 13 * analyte 13 + a 14 * NPY ) .$$

Using five of the markers listed in Table 13 (ACTH, BDNF, IL-10, IL-13, and IL-18), a diagnostic score was established based on the following algorithm:

Depression diagnosis score=f(a1*ACTH+a2*BDNF+a3*IL-10+a4*IL-13+a5*IL-18).

Several other examples of depression algorithms using different marker sets were established and are shown in Tables 14-20. In particular, MDD algorithms with subsets of four to six analytes have shown diagnosis sensitivity in the range of 70% to 90%.

TABLE 13

| Analyte | Relationship to Depression |
|---|---|
| Cortisol | key stress hormone; can be elevated in MDD |
| ACTH | produced and secreted by pituitary; can be elevated in |
| | patients with hypercortisolemia |
| Interleukin-1 | strongly involved in activation of the HPA axis. |
| Interleukin-18 | may be elevated in patients with MDD |
| BDNF | involved in regulation of the HPA axis, lower in |
| | MDD, responds to treatment |
| Leptin | inhibits appetite by activating several neuroendocrine |
| | systems, including the HPA axis |
| Serotonin | both bipolar and unipolar depression are associated with |
| | a decrease in the functional levels of serotonin |
| | (5- HT2) activity |
| Dopamine | plasma dopamine levels are negatively correlated with |
| | HAM-D scores in depression |
| Norepinephrine | significantly lower in bipolar disease; may be useful in |
| | distinguishing unipolar from bipolar depression |
| Thyroid | lower TSH and higher T₄ levels associated with current |
| Stimulating | depressive syndrome in young adults |
| Hormone | |
| Corticotropin- | higher levels in severe major depressive disorder |
| releasing | |
| hormone | |
| Arginine | plasma levels elevated in patients with MDD |
| vasopressin | |
| Thyroxine (T₄) | important for action of thyroid hormones in brain |

TABLE 14
Complete 12 member HPA centric depression panel
Analyte

Cortisol
ACTH
Interleukin-1
Interleukin-18
BDNF
Leptin
Dopamine
Norepinephrine
Thyroid Stimulating Hormone
Corticotropin-releasing hormone
Arginine vasopressin
Thyroxine (T₄)

TABLE 15
Representative ten member HPA centric depression panel
Analyte

Cortisol
ACTH
Interleukin-1
Interleukin-18
BDNF
Dopamine
Leptin
Thyroid Stimulating Hormone
Corticotropin-releasing hormone
Arginine vasopressin

TABLE 16
Representative nine member HPA centric depression panel
Analyte

Cortisol
ACTH
Interleukin-1
Interleukin-18
BDNF
Leptin
Thyroid Stimulating Hormone
Corticotropin-releasing hormone
Arginine vasopressin

TABLE 17
Representative eight member HPA centric depression panel
Analyte

Cortisol
ACTH
Interleukin-1
Interleukin-18
BDNF
Thyroid Stimulating Hormone
Corticotropin-releasing hormone
Arginine vasopressin

TABLE 18
Representative seven member HPA centric depression panel
Analyte

Cortisol
ACTH
Interleukin-1
Interleukin-18
BDNF
Thyroid Stimulating Hormone
Arginine vasopressin

TABLE 19
Representative six member HPA centric depression panel
Analyte

Cortisol
ACTH
Interleukin-1
Interleukin-18
BDNF
Thyroid Stimulating Hormone

TABLE 20
Representative five member HPA centric depression panel
Analyte

Cortisol
ACTH
Interleukin-1
Interleukin-18
BDNF

The analyte lists shown in Tables 14-20 represent sub-sets of HPA-related biomarkers for depression. These panels are not meant to be the only possible combinations of marker that would be useful; they do, however, represent panels that should provide statistically valid adjuncts to diagnosis and monitoring patients with depression. It is noted that since many of these proteins are known to have diurnal variations (e.g., cortisol, ACTH, leptin, and TSH), it is useful to assay samples taken during a prescribed time period (e.g., 2:00 to 6:00 PM).

### Example 5

### Diagnostic Markers of Depression

Methods provided herein were used to develop a biomarker library and an algorithm for determining depression scores that are useful to diagnose or determine predisposition to MDD, and to evaluate a subject's response to anti-depressive therapeutics. Multiplexed detection systems were used to phenotype molecular correlates of depression. Three statistical approaches were used for biomarker assessment and algorithm development: (1) univariate analysis for testing the distribution of biomarkers for association with MDD; and (2) linear discriminant analysis (LDA) and (3) binary logistic regression for algorithm construction.

Univariate Analysis of Individual Analyte Levels:

Using the Student's T-test, serum levels of each of the analytes were tested using Luminex multiplex technology and we compared depressed versus normal subjects. The level of significance was set at α≦0.05. Univariate analysis separately explores each variable in a data set. This method looks at the range of values and the central tendency of the values, describes the pattern of response to the variable, and describes each variable on its own. By way of example, FIG. 10 shows the distribution of blood levels for marker X in a hypothetical series of six MDD patients before and after treatment. The first point to be made from this graph is that the concentration of marker X was higher in untreated MDD patients as opposed to control subjects. Second, the levels of marker X in the MDD patients after treatment was similar to that of the control.

The Student's t-Test was then used to compare the two sets of data and to test the hypothesis that a difference in their means is significant. The difference in the means is of statistical significance on the basis of how many standard deviations separate the means. The distance between means is judged significant using Student's t-statistic and its corresponding probability or significance that the absolute value of the t-statistic could be this large or larger by chance. In addition, the t-Test takes into account whether the populations are independent or paired. An independent t-Test can be used when two groups are thought to have the same overall variance but different means. This test can provide support for a statement about how a given population varies from an ideal measure, such as how a treated group compares with an independent control group. The independent t-Test can be performed on data sets with an unequal number of points. In contrast, the paired test is used only when two samples are of equivalent size (i.e., include same number of points). This test assumes that the variance for any point in one population is the same for the equivalent point in the second population. This test can be used to support conclusions about a treatment by comparing experimental results on a sample-by-sample basis. For example, a paired t-Test can be used to compare results for a single group before and after a treatment. This approach can help to evaluate two data sets whose means do not appear to be significantly different using the independent t-Test. During the test(s), the Student's t-Statistic for measuring the significance of the difference between the means is calculated, and the probability (p-Value) that the t-Statistic takes on its value by chance. The smaller the p-Value, the more significant the difference in the means. For many biological systems, an alpha level (or level of significance) of p>0.05 represents the probability that the t-Statistic is achievable just by chance.

For example, application of the student's t-Test to the data in FIG. 10 (where there are equal numbers of points in each group) showed that the difference in marker X expression between control subjects and patients with MDD was statistically significant at p>0.002, and the difference in the MDD patients pre- and post-treatment was significant with p>0.013. In contrast, there was no statistically significant difference between the control group and the MDD patients after treatment (p>0.35).

Such data is used to obtain a frequency distribution for the variable. This is achieved by all the values of the variable in order from lowest to highest. The number of appearances for each value of the variable is a count of the frequency with which each value occurs in the data set. By way of example, if a MDD score is calculated using an algorithm as described herein, the patient population can be separated into groups having the same MDD score. If patients are monitored before and after treatment, the frequency for each MDD score can be established, and the effectiveness of the treatment can be ascertained.

PCA and PLS-DA:

PCA is mathematically defined as an orthogonal linear transformation that transforms the data to a new coordinate system such that the greatest variance by any projection of the data comes to lie on the first coordinate (called the first principal component), the second greatest variance on the second coordinate, and so on. PCA is used for dimensionality reduction in a data set by retaining those characteristics of the data set that contribute most to its variance, by keeping lower-order principal components and ignoring higher-order ones. Such low-order components often contain the “most important” aspects of the data.

PLS-DA was performed in order to sharpen the separation between groups of observations by rotating PCA components such that a maximum separation among classes was obtained, providing information as to which variables carry the class separating information. PLS-DA and other techniques were used to demonstrate the segregation of normal subjects and depressed patients using the MDD panel to measure serum levels of 16 analytes, all 18 analytes, or sub-sets of four to nine analytes, as examples.

Algorithm Based on Linear Discriminant Analysis (LDA):

To identify the analytes that contribute the most to discrimination between classes (e.g., depressed vs. normal), a stepwise method of LDA from SPSS 11.0 for Windows was used with following settings: Wilks' lambda (A) method was used to select analytes that maximize the cluster separation and analyte entrance into the model was controlled by its F-value. A large F-value indicates that the level of the particular analyte is different between the two groups, and a small F-value (F<1) indicates that there is no difference. In this method, the null hypothesis is rejected for small values of Λ. Thus, the aim was to minimize Λ.

To construct a list of analyte predictors, the F-values for each of the analytes was calculated. Starting with the analyte having the largest F-value (the analyte that differs the most between the two groups), the value of Λ was determined. The analyte with the next largest F-value was then added to the list and Λ was recalculated. If the addition of the second analyte lowered the value of Λ, it was kept in the list of analyte predictors. The process of adding analytes one at a time was repeated until the reduction of Λ no longer occurred.

Cross-validation, a method for testing the robustness of a prediction model, was then carried out. To cross-validate a prediction model, one sample was removed and set aside, the remaining samples were used to build a prediction model based on the pre-selected analyte predictors, and a determination was made as to whether the new model was able to predict the one sample not used in building the new model correctly. This process was repeated for all samples one at a time, and a cumulative cross-validation rate was calculated. The final list of analyte predictors was determined by manually entering and removing analytes to maximize the cross-validation rate, using information obtained from the univariate analyses and cross-validations. The final analyte classifier was then defined as the set of analyte predictors that gives the highest cross-validation rate.

### Example 6

### Choosing Multiple Biomarkers for MDD

Using the Student's t-Test, serum levels of about 100 analytes were tested using Luminex multiplex technology. The data were subsequently analyzed for a comparison of depressed versus normal subjects. The level of significance was set at α≦0.05. After the initial study, the analytes listed in Table 21 were chosen based on statistical significance. This was followed by multivariate analysis (PCA, PLS-DA, LDA) to identify markers that are useful to distinguish MDD patients from normal populations.

Table 21 lists nine biomarkers and indicates the nature of the potential relationship of each analyte to the pathophysiology of depression disorder. In practical use, a smaller group of biomarkers may be sufficient to aid in diagnosis and treatment monitoring for MDD, either with or without additional information derived from a clinical evaluation. Several others examples using different marker sets were established and are shown in Tables 22-27. MDD algorithms with sub-sets of four to nine analytes have demonstrated diagnostic sensitivity in the range of 70% to 90%. These groups, or combinations of these groups with other information, also are used to distinguish different subtypes of unipolar depression, stratify patients, and/or to select and monitor treatments.

TABLE 21

| ANALYTE | RELATIONSHIP TO DEPRESSION |
|---|---|
| IL-1 | strongly involved with activation of the HPA axis in MDD |
| IL-13 | usually acts as an anti-inflammatory cytokine |
| IL-7 | may be a neuronal growth factor |
| IL-6 | plasma IL-6 is elevated in MDD |
| IL-18 | stress related release of IL-18 in CNS and plasma |
| A2M | associated with inflammatory disease and depression |
| IL-15 | a novel proinflammatory cytokine |
| IL-10 | usually acts as an anti-inflammatory cytokine |
| B2M | can be associated with chronic inflammatory conditions |

TABLE 22
Complete nine member inflammatory
marker centric depression panel
ANALYTE

IL-1
IL-13
IL-7
IL-6
IL-18
A2M
IL-15
IL-10
B2M

TABLE 23
Representative eight member inflammatory
marker centric depression panel
ANALYTE

IL-1
IL-13
IL-7
IL-6
IL-18
A2M
IL-15
IL-10

TABLE 24
Representative seven member inflammatory
marker centric depression panel
ANALYTE

IL-1
IL-13
IL-7
IL-6
IL-18
A2M
IL-10

TABLE 25
Representative six member inflammatory
marker centric depression panel
ANALYTE

IL-1
IL-13
IL-6
IL-18
A2M
IL-10

TABLE 26
Representative five member inflammatory
marker centric depression panel
ANALYTE

IL-1
IL-13
IL-18
A2M
IL-10

TABLE 27
Representative four member inflammatory
marker centric depression panel
ANALYTE

IL-13
IL-18
A2M
IL-10

The potential relevance of each marker in Tables 21-27 to MDD is discussed in further detail herein.

### Example 7

### Use of an Algorithm to Calculate MDD Scores and Assess Treatment

Using all nine of the markers listed in Table 21, as well as NPY, a diagnostic score was established based on the following algorithm:

Depression diagnosis score=f(a1*IL-1+a2*IL-13+a3*IL-7+a4*IL-6+a5*IL-18+a6*A2M+a7*IL-15+a8*IL-10+a9*B2M+a10*NPY

Using five of the markers listed above (A2M, IL-1, IL-10, IL-13, and IL-18), a diagnostic score was established based on the following algorithm:

Depression diagnosis score=f(a1*A2M+a2*IL-1+a3*IL-10+a4*IL-13+a5*IL-18).

Several other examples of depression algorithms using different marker sets were established and are shown in Tables 23-27. MDD algorithms with subsets of four to six analytes have shown diagnostic sensitivity in the range of 70% to 90%. The analyte lists shown in Tables 23-27 represent sub-sets of immune-related biomarkers for depression. These panels are not meant to be the only possible combinations of marker that would be useful; they do, however, represent panels that should provide statistically valid adjuncts to diagnosis and monitoring patients with depression.

### Example 8

### Diagnostic Markers of Depression

Methods as described herein were used to develop an algorithm for determining depression scores that are useful to, for example, diagnose or determine predisposition to major depressive disorder (MDD), or evaluate response to anti-depressive therapeutics. Multiplexed detection systems such as those described herein were used to phenotype molecular correlates of depression. Preliminary studies indicated the value in using multiplexed antibody arrays to develop a panel of biomarkers in populations with MDD. The availability of biological markers reflecting psychiatric state (e.g., the type of pathology, severity, likelihood of positive response to treatment, and vulnerability to relapse) can impact both the appropriate diagnosis and treatment of depression. This systematic, highly parallel, combinatorial approach was proposed to assemble “disease specific signatures” using algorithms as described herein. The algorithm can then be used to determine the status of individuals and patients previously diagnosed with MDD. Table 28 exemplifies an MDD disease-specific biomarker library—a collection of tests useful to quantify proteins expressed in human serum.

Table 28 lists a series of biomarkers that have been evaluated as individual biomarkers of MDD as well as members of a disease specific multi-analyte panel. Two statistical approaches can be used for biomarker assessment and algorithm development: (1) univariate analysis for testing the distribution of biomarkers for association with MDD; and (2) linear discriminant analysis (LDA) and binary logistic regression for algorithm construction.

Univariate analysis of individual analyte levels: Using the Students T test, serum levels of each of the analytes tested using Luminex multiplex technology were analyzed for comparison of depressed versus normal subjects. The level of significance was set at p≦0.05.

Table 29 lists the biomarker measurements and p values (determined by an independent T test) for a subset of markers related to the HPA axis and metabolism.

Table 30 includes a partial list of different groups of metabolic and HPA biomarker combinations that can be used to generate diagnostic scores. These groups, or combination of these groups, can be used to diagnose different subtypes of depression disorder, or select and monitor treatments. In addition, other markers also can be added to these groups to further classify patients and develop a series of optimal panels for patient stratification as well as for diagnosis and management of depression.

Table 31 indicates how subsets of a biomarker panel affect the overall predictability of the resulting panel when the number of markers was changed from a nine (9) marker panel to a three (3) marker panel. As is apparent from this table, removal of some markers from a panel had little effect on the percentage of correct predictions. By adding and subtracting analytes and determining the resultant predictability, the panel is optimized. Depending upon the criteria set for predictability (e.g., the ability to properly diagnose vs. the ability to predict the efficacy of an intervention), clinically valuable information is generated.

TABLE 28
MDD Biomarker Library

| Gene Symbol | Biomarker Name | Cluster |
|---|---|---|
| — | Cortisol | HPA axis |
| EGF | Epidermal Growth Factor | HPA axis |
| GCSF | Granulocyte Colony Stimulating Factor | HPA axis |
| PPY | Pancreatic Polypeptide | HPA axis |
| ACTH | Adrenocorticotropic hormone | HPA axis |
| AVP | Arginine Vasopressin | HPA axis |
| CRH | Corticotropin-releasing hormone | HPA axis |
| A1AT | Alpha 1 Antitrypsin | Inflammation |
| A2M | Alpha 2 Macroglobin | Inflammation |
| ApoC3 | Apolipoprotein CIII | Inflammation |
| CD40L | CD40 ligand | Inflammation |
| IL-6 | Interleukin 6 | Inflammation |
| IL-13 | Interleukin 13 | Inflammation |
| IL-18 | Interleukin 18 | Inflammation |
| IL-1ra | Interleukin 1 Receptor Antagonist | Inflammation |
| MPO | Myeloperoxidase | Inflammation |
| PAI-1 | Plasminogen activator inhibitor-1 | Inflammation |
| TNFA | Tumor Necrosis Factor A | Inflammation |
| ACRP30 | Adiponectin | Metabolic |
| ASP | Acylation Stimulating Protein | Metabolic |
| FABP | Fatty Acid Binding Protein | Metabolic |
| INS | Insulin | Metabolic |
| LEP | Leptin | Metabolic |
| PRL | Prolactin | Metabolic |
| RETN | Resistin | Metabolic |
| — | Testosterone | Metabolic |
| TSH | Thyroid Stimulating Hormone | Metabolic |
| BDNF | Brain-derived neurotrophic factor | Neurotrophic |
| S100B | S100B | Neurotrophic |
| NTF3 | Neurotrophin 3 | Neurotrophic |
| GDNF | Glial cell line derived neurotrophic | Neurotrophic |
| | factor | |
| ARTN | Artemin | Neurotrophic |

TABLE 29
Serum Biomarker Levels in MDD and Normal subjects

| Biomarker | Cluster | MDD | Control | p value |
|---|---|---|---|---|
| Cortisol | HPA axis | 93.8 | 88.5 | 0.4 |
| Epidermal Growth Factor | HPA axis | 306.9 | 162.5 | 0.09 |
| Granulocyte Colony | HPA axis | 11.3 | 7.9 | 0.05 |
| Stimulating Factor | | | | |
| Pancreatic Polypeptide | HPA axis | 120.9 | 75.8 | 0.1 |
| Adiponectin | Metabolic | 3.5 | 3 | 0.3 |
| Acylation Stimulating | Metabolic | 16558 | 11542 | 0.03 |
| Protein | | | | |
| Fatty Acid Binding | Metabolic | 0.75 | 0.7 | 0.8 |
| Protein | | | | |
| Insulin | Metabolic | 13.6 | 3.5 | 0.05 |
| Leptin | Metabolic | 6.3 | 3.8 | 0.2 |
| Prolactin | Metabolic | 1.34 | 0.5 | 0.04 |
| Resistin | Metabolic | 1.33 | 0.85 | 0.02 |
| Testosterone | Metabolic | 2.4 | 2.8 | 0.2 |
| Thyroid Stimulating | Metabolic | 2.5 | 2.3 | 0.5 |
| Hormone | | | | |

TABLE 30
Partial List of Biomarker Combinations
(9 member Panels) Marker Combination

Cortisol, ACRP30, PPY, EGF, G-CSF, PRL, RETN, ASP, TSH
Cortisol, ACRP30, EGF, FABP, LEP, PRL, RETN, Testosterone, TSH
Cortisol, ACRP30, EGF, FABP, PPY, PRL, RETN, TSH, Testosterone
Cortisol, ACRP30, EGF, Insulin, PPY, PRL, RETN, TSH, Testosterone
Cortisol, ACRP30, G-CSF, INS, PPY, PRL, RETN, TSH, Testosterone
ASP, ACRP30, G-CSF, INS, PPY, PRL, RETN, TSH, Testosterone
ASP, Cortisol, G-CSF, INS, PPY, PRL, RETN, TSH, Testosterone

TABLE 31
Example of a Biomarker Combination
and the Predictability of Subsets

| | % Correct |
|---|---|
| Marker Combination | Prediction |
| A1AT, A2M, ApoC3, EGF, G-CSF, ICAM-1, PRL, | 91.7 |
| RETN, TNFA | |
| A1AT, A2M, ApoC3, EGF, G-CSF, ICAM-1, PRL, | 87.5 |
| TNFA | |
| A1AT, ApoC3, EGF, G-CSF, ICAM-1, PRL, TNFA | 89.6 |
| A1AT, ApoC3, EGF, ICAM-1, PRL, TNFA | 88.5 |
| A1AT, ApoC3, EGF, PRL, TNFA | 88.5 |
| ApoC3, EGF, PRL, TNFA | 88.5 |
| ApoC3, PRL, TNFA | 87.5 |

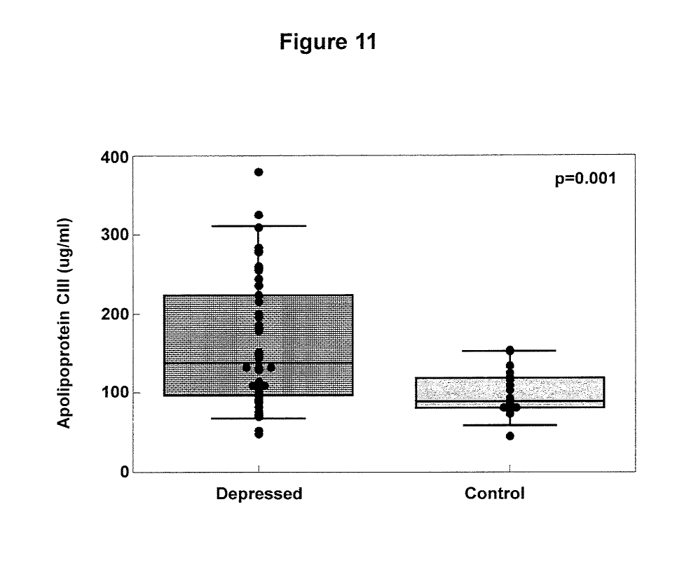

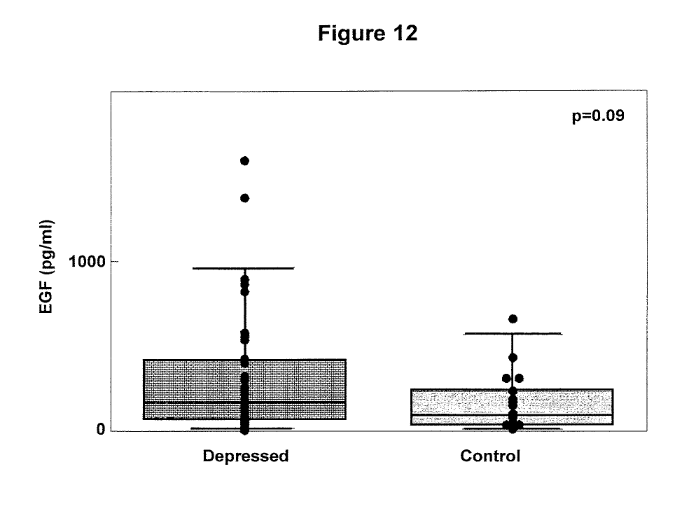

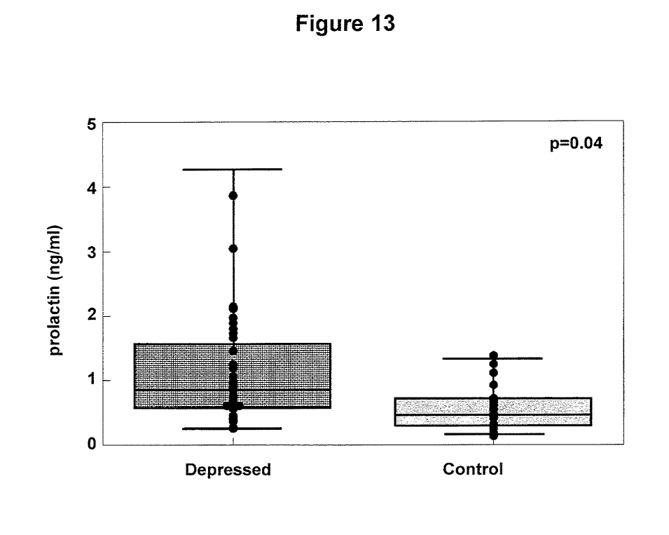

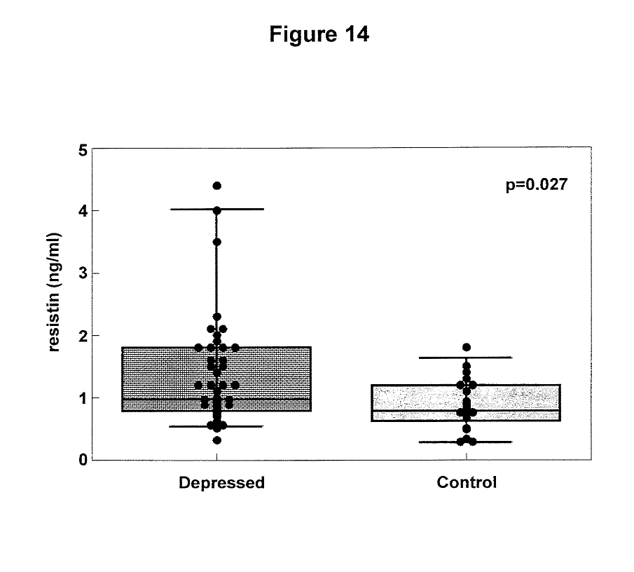

Individual biomarkers were evaluated in further studies. In particular, levels of apolipoprotein CIII, epidermal growth factor, prolactin, and resistin were measured in serum from 50 depressed patients and 20 age-matched normal controls. As shown in FIGS. 11-14, each of these markers was present at a higher concentration in depressed patients than normal controls.

### Example 9

### Depression Biomarkers that Change after Drug Therapy

The present state of the art for monitoring depression is based on periodic clinical interviews rather than biological testing. Placebo effects, poly-pharmacy and inaccuracy of patient reporting can make it difficult to monitor efficacy and determine appropriate treatment. As disclosed herein, a biomarker panel can be used to predict future clinical outcomes or suitable dose adjustments based on biomarker measurement. This establishes the correlation between changes in the biomarker and changes in drug exposure, measured as plasma concentration or dose. One of the challenges is to prospectively plan and properly implement the model and to determine which metrics of drug exposure and biomarker time course are able to predict clinical outcomes.

FIG. 5 is a flow diagram depicting a process for using diagnostic scores to aid in diagnosis, selecting treatments, and monitoring the treatment process. In this example, multiple biomarkers are measured from a patient blood sample at baseline and at time points after initiation of therapy. Since the biomarker pattern may be different for patients who are on antidepressants as opposed to cognitive, electroconvulsive, or behavioral therapy, changes in the diagnostic score toward that of normal patients are an indication of effective therapy. As the cumulative experience with therapies increases, specific biomarker panels and/or algorithms are derived to monitor therapy with specific antidepressants, etc.

Since patients on therapy with antidepressants can become resistant, patients are monitored periodically by drawing blood, measuring biomarker levels, and generating diagnostic scores. Such multiple measurements are used to continually adjust treatment (e.g., dose and schedule), to periodically assess the patient's status, and to optimize and select new single or multiple agent therapeutics. In identifying biomarkers that change after initiation of therapy, the optimal experimental design is a prospective clinical trial wherein drug naïve patients are monitored during the course of therapy. However, cross-sectional studies can be used to identify biomarkers that are up or down regulated during treatment. Some examples of MDD biomarkers that are potentially altered subsequent to antidepressant therapy are shown in Table 31. While this example focuses on the level of each protein in serum (or plasma), similar studies can be done on mRNA expression (e.g., in isolated lymphocytes from patients undergoing treatment).

TABLE 31
Biomarker values in MDD patients on antidepressant
therapy vs. those not on therapy

| | | MDD No | MDD + | |
|---|---|---|---|---|
| Biomarker Name | Cluster | Drug | Drug | Control |
| Cortisol | HPA axis | 91 | 96 | 88.5 |
| Epidermal Growth Factor | HPA axis | 220 | 365 | 162.5 |
| Granulocyte Colony | HPA axis | 12.3 | 10.2 | 7.9 |
| Stimulating Factor | | | | |
| Pancreatic Polypeptide | HPA axis | 138 | 108 | 75.8 |
| Adiponectin | Metabolic | 3.7 | 3.3 | 3 |
| Acylation Stimulating | Metabolic | 15343 | 17062 | 11542 |
| Protein | | | | |
| Fatty Acid Binding | Metabolic | 4 | 0.8 | 0.7 |
| Protein | | | | |
| Insulin | Metabolic | 8.9 | 16.9 | 3.5 |
| Leptin | Metabolic | 3.4 | 7.6 | 3.8 |
| Prolactin | Metabolic | 0.96 | 1.57 | 0.5 |
| Resistin | Metabolic | 1.24 | 1.41 | 0.85 |
| Testosterone | Metabolic | 2.31 | 2.47 | 2.8 |
| Thyroid Stimulating | Metabolic | 2.24 | 2.78 | 2.3 |
| Hormone | | | | |

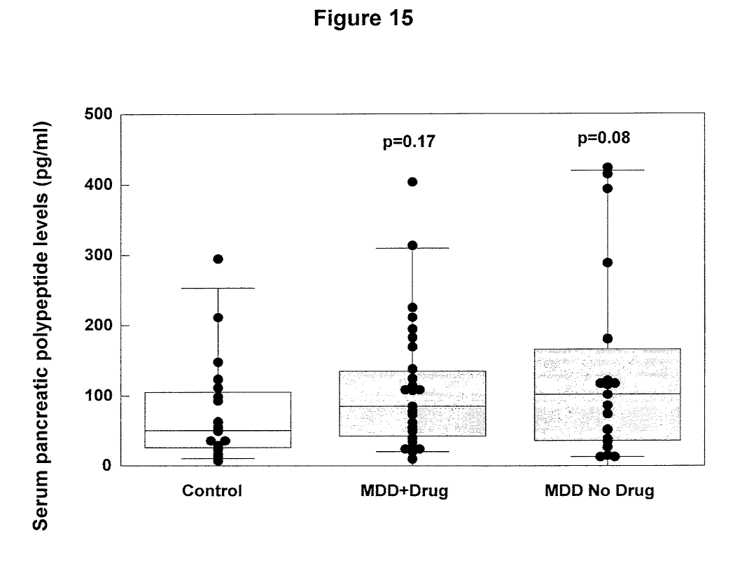

An example of the raw data for a single biomarker (pancreatic polypeptide) is shown in FIG. 15. Each dot represents an individual subject. The boxes represent the 25^{th} through 75^{th} percentiles, while the whiskers indicate the 5^{th} and 95^{th} percentiles. In this case, it appeared that the mean values of serum pancreatic polypeptide in patients on antidepressants were similar to serum pancreatic polypeptide levels in normal subjects.

While this exercise suggests that serum levels of certain individual markers may change upon therapy, this was a cross-sectional study that did not take into account how therapy may affect individual patients.

It was proposed to monitor therapy by measuring groups of biomarkers at baseline and at time points after initiation of therapy. By way of example, FIG. 10 shows the distribution of blood levels of marker X in a hypothetical series of six MDD patients before and after treatment. The first point to be made from this graph is that the concentration of marker X is higher in untreated MDD patients as opposed to control subjects. Second, the levels of marker X in the MDD patients after treatment is similar to that of controls. The Student's t-Test is then used to compare two sets of data and to test the hypothesis that a difference in their means is significant. The difference in the means is of statistical significance on the basis of how many standard deviations that they are apart. The distance is judged significant using Student's t-statistic and its corresponding probability or significance that the absolute value of the t-statistic could be this large or larger by chance. In addition, the t-Test takes into account whether the populations are independent or paired. An Independent t-Test can be used when two groups are thought to have the same overall variance but different means. It can provide support for a statement about how a given population varies from some ideal measure, for example how a treated group compares with an independent control group. The independent t-Test can be performed on data sets with an unequal number of points. The paired test is executed only when two samples are of equivalent size (i.e., same number of points). It assumes that the variance for any point in one population is the same for the equivalent point in the second population. This test can be used to support conclusions about a treatment by comparing experimental results on a sample-by-sample basis. For example, this can be used to compare results for a single group before and after a treatment. This approach can help to evaluate two data sets whose means do not appear to be significantly different using the Independent t-Test. This test is performed only if the two data sets have an equal number of points. During the test(s), the Student's t-Statistic for measuring the significance of the difference of the means is calculated, and the probability (p-value) that the t-Statistic takes on its value by chance. The smaller the p-value, the more significant the difference in the means. For many biological systems, a level of significance of p>0.05 represents the probability that the t-Statistic is not achievable just by chance.

For example, application of the Student's t-Test to the data in FIG. 10, where there are equal number of points, showed that the difference in marker X expression between control subjects and patients with MDD was statistically significant (p=0.002), and the difference pre- and post-treatment also was significant (p=0.013). Lastly, there was no statistically significant difference between the control group and the MDD patients after treatment (p=0.35)

Such data can be used to obtain a frequency distribution of the data for the variable. This is done by identifying the lowest and highest values of the variable and then putting all the values of the variable in order from lowest to highest. The number of appearances of each value of the variable is a count of the frequency with which each value occurs in the data set. For example, if the MDD score is calculated using the algorithm, the patient population can be placed into groups having the same MDD score. If the 25 patients are monitored before and after treatment, one can establish what the frequency is for each MDD score and ascertain whether the treatment is effective. Table 32 presents an example of data in which the MDD scores were established at baseline and at week 4 post treatment (Rx). As can be seen, the number of patients with high scores (9 and 10) decreased from 13 to 6 after treatment, with a concomitant increase in the lower range of MDD scores (6 and 7) from 6 to 13, indicative of treatment efficacy.

TABLE 32

| MDD Score | # Pts before treatment | # Pts after treatment |
|---|---|---|
| 6 | 2 | 6 |
| 7 | 4 | 7 |
| 8 | 6 | 6 |
| 9 | 9 | 5 |
| 10 | 4 | 1 |

### Example 10

### Biological Hypermapping for MDD

To populate each group of biomarkers for a particular clinical condition, a list of marker candidates is selected that best reflects the state of the group reflective to changes in the condition. In the case of MDD, candidate biomarkers were selected based upon clinical studies, and were sub-classified using a bioinformatic approach based on their role in MDD. The biomarkers utilized in the present example are listed in Tables 1 to 3 above.

While any combination of the markers in each group could have been used to construct a hyperspace vector (V₁ . . . Vₙ) the biomarkers that were used were taken from a library of biomarker tests that previously had been evaluated for their suitability for quantitative measurement, based on the accuracy and precision of the assay in biological fluids (particularly blood, serum, and plasma).

The second step in the processes provided herein typically is to design and collect clinical study data. Clinical samples are collected from patients having the disease of interest. Samples are collected from patients that typically have been diagnosed by known “gold standard” criteria. A set of age- and gender-matched samples also is obtained from normal subjects. The patient samples can be from a group of subjects with different disease states/severities/treatment choices/treatment outcomes, for example. Patient selection criteria depend upon the test outcome understudied. In the case of MDD, patients with different disease severities, durations, reoccurrences, treatment options (e.g., different classes of antidepressants), and treatment outcomes were selected. Normal subjects were required to have no history of depression, both personally and in their immediate family members, in addition to being free form confounding diseases.

The third step of the methods provided herein typically is to use the measured marker data from the clinical study samples to construct a hyperspace vector from each group of markers. There are several choices of algorithms for constructing hyperspace vectors. The chosen method generally depends on the disease conditions under study. For example, in the development of a diagnostic test for MDD, the clinical result is depressed vs. not depressed. Thus, a binary logistic regression optimization is used to fit the clinical data with selected markers in each group against the clinical results from “gold standard” diagnosis. The result of the fit is a set of coefficients for the list of markers in the group. For example, A1AT (I1), A2M (I2), apolipoprotein CIII (I3), and TNF alpha (I4) were selected as the four markers representing the inflammatory group. Using binary logic regression against clinical results, four coefficients and the constants for these markers were calculated. The vector for the inflammatory group was constructed as follows:

V_{infla}=1/(1+exp−(CI0+CI1*I1+CI2*I2+CI3*I3+CI4*I4)) (1)

Where CI0=−7.34
CI1=−0.929
CI2=1.10
CI3=5.13
CI4=6.48
   V_{infla} represented the probability of whether a given patient had MDD using the measured inflammatory markers.

In the same way, vectors for other groups of markers were derived for MDD. Four markers were chosen to represent the metabolic group: M1=ASP, M2=prolactin, M3=resistin, and M4=testosterone. Using the same method of binary logistic regression described above for the clinical data, a set of coefficients and a vector summary were developed for patient metabolic response:

Vₘₑₜₐ=1/(1+exp−(Cm0+Cm1*M1+Cm2*M2+Cm3*M3+Cm4*M4)) (2)
Where Cm0=−1.10
Cm1=0.313
Cm2=2.66
Cm3=0.82
Cm4=−1.87
   Vₘₑₜₐ represented the probability of whether a given patient had MDD using the measured metabolic markers.

Two markers were chosen to represent the HPA group: H1=EGF and H2=G-CSF. Again, using the same method of binary logistic regression on the clinical data as above, a set of coefficients and a vector summary were developed for patient HPA response:

Vₕₚₐ=1/(1+exp−(Ch0+Ch1*H1+Ch2*H2)) (3)

Where Ch0=−1.87
Ch1=7.33
Ch2=0.53
   Vₕₚₐ represented the probability of whether a given patient has MDD using the measured HPA markers.

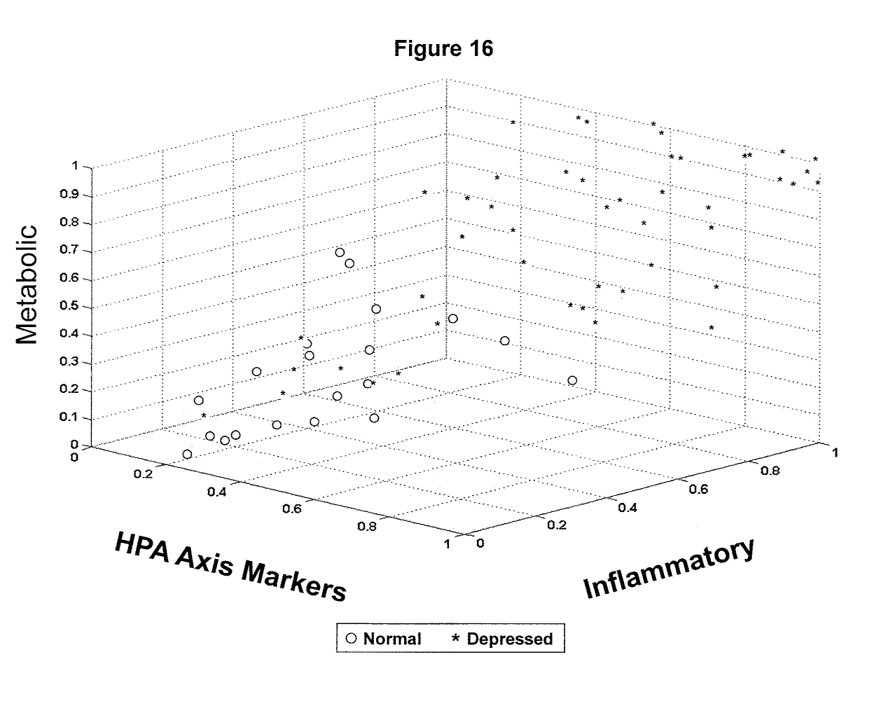

Using these three parameters, a hypermap for MDD was constructed. FIG. 16 is a hypermap representation of patients diagnosed with MDD and a normal subject control group. This hypermap was constructed using data collected from the subjects by measurement and analysis of inflammatory, metabolic, and HPA marker groups. Asterisks represent patients with MDD, while circles represent normal subjects.

The last step of the methods described herein typically is to construct a diagnostic based on the hypermap. When correct marker groups and markers are selected, a hypermap for the disease can be constructed so that disease patients and healthy controls are represented in different regions of the hypermap. One can use a hypermap for simple one parameter diagnostics (e.g., the likelihood that an individual has a disease). Alternatively, one can construct more complicated diagnostics, perhaps indicating whether a particular patient will react with particular treatments, depending on the region of the hypermap into which the patient's marker response set falls. Such methods also can be used to determine whether a patient or falls into a specific sub-class that can be used to predict disease course, select a specific treatment regimen, or provide information regarding disease severity, for example.

In some cases, a method as provided herein can further include, if it is determined that a patient is likely to have MDD, comparing the result of hypermaps for the patient prior to and subsequent to therapy for the MDD, determining whether a change in biomarker pattern has occurred, and determining whether any such change is reflected in the clinical status of the patient. Accumulation of sufficient data on individual patients would allow for prediction of certain aspects of response to a specific treatment (e.g., an antidepressant, psychotherapy, or cognitive behavior modification), such as a positive or negative response or a profile for a specific side effect (e.g., sexual dysfunction or loss of libido).

To generate patient specific data, blood was drawn, the concentrations of selected markers in the plasma or sera were measured, and the measured marker concentration data were added into the formula, resulting in a diagnostic test score for MDD specific to individual patients. This method is also useful for optimizing treatment, for example. By hypermapping patients to a master hypermap derived from a large number of patients from whom clinical data is available, including data with regard to response to specific drugs, the response to a specific drug can be estimated based on the response of MDD patients with similar characteristics.

In the present example, a simple diagnostic for MDD was developed by combining three hypermap vectors (V_{infa}, V_{HPA}, and V_{Meta}) using a binary logic regression against clinical data to build a formula for the likelihood of patient having MDD. This resulted in equation (4):

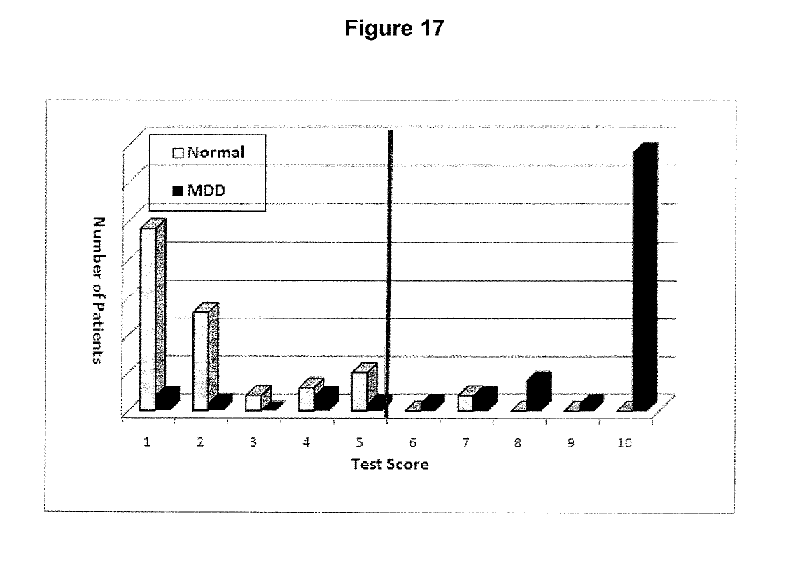

P_{MDD}=1/(1+Exp−(Cp0+Cp1*V_{infla}+Cp2*Vₘₑₜₐ+Cp3*Vₕₚₐ)) (4)

Where Cp0=−3.87
Cp1=5.46
Cp2=3.47
Cp3=−0.66
   P_{MDD} represents the probability of whether a patient has MDD using groups of markers from the inflammatory, metabolic, and HPA groups. FIG. 17 illustrates the results of applying the formula to a set of clinical samples from MDD patients and age-matched control subjects. The test score=10×P_{MDD}.

The same method is used with different markers in the different groups to construct a hypermap, which in turn can be used to construct diagnostic tests. For example, one or more markers in the inflammatory, metabolic, and/or HPA groups are replaced to construct a hypermap and generate a diagnostic. Alternatively or in addition, neurotrophic marker groups are included to construct a mood disorder (e.g., MDD or bipolar disease) hypermap and generate a diagnostic formula. In the present example, where the question to be tested was whether or not a subject had MDD, binary logistic regression was used to construct hypermap group vectors. It is noted that other regression methods also can be used to construct the vectors for more complicated questions and/or situations.

### Example 11

### Use of Hypermapping to Assess Changes in Disease State

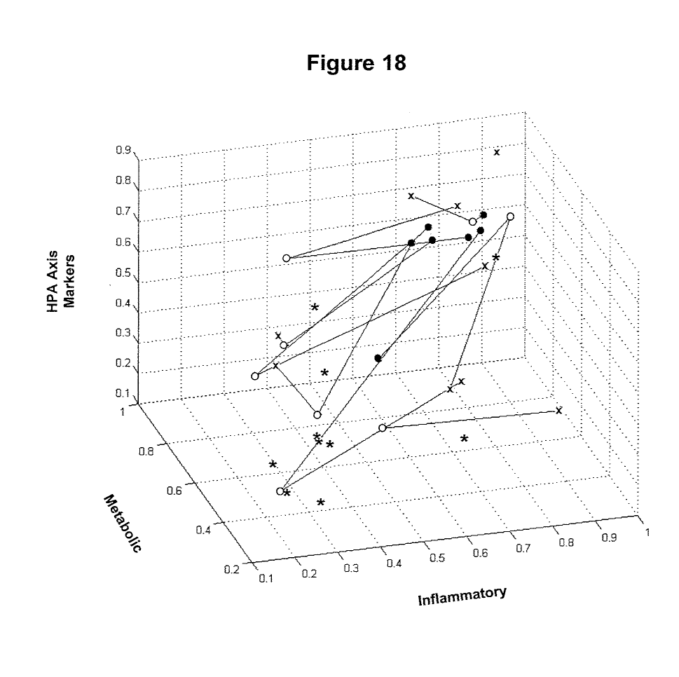

As noted above, certain external factors, diseases, and therapeutics can influence the expression of one or more biomarkers that are components of a vector within a hypermap. FIG. 18 is a hypermap that was developed to demonstrate the response pattern for a series of MDD patients who initiated therapy with the antidepressant LEXAPRO™. FIG. 18 shows changes in BHYPERMAP™ in a subset of Korean MDD patients after treatment with LEXAPRO™. MDD patients at baseline are represented by “x.” Patients after 2-3 weeks of treatment are represented by open circles, and after 8 weeks of treatment by solid circles. The asterisks represent normal subjects. This demonstrates that the technology described herein can be used to define changes in an individual pattern in response to antidepressant therapy.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for diagnosing depression in a human subject, comprising
(a) providing numerical values for a plurality of parameters predetermined to be relevant to depression;
(b) individually weighting each of said numerical values by a predetermined function, each function being specific to each parameter;
(c) determining the sum of the weighted values;
(d) determining the difference between said sum and a control value; and
(e) if said difference is greater than a predetermined threshold, classifying said subject as having depression or, if said difference is not different than said predetermined threshold, classifying said subject as not having depression.

2. The method of claim 1, wherein said depression disorder is major depressive disorder.

3. The method of claim 1, wherein said parameters are selected from the group consisting of brain-derived neurotrophic factor (BDNF), interleukin-7 (IL-7), interleukin-10 (IL-10), interleukin-13 (IL-13), interleukin-15 (IL-15), interleukin-18 (IL-18), fatty acid binding protein (FABP), alpha-1 antitrypsin (A1AT), beta-2 macroglobulin (B2M), factor VII, epithelial growth factor (EGF), alpha-2-macroglobulin (A2M), glutathione S-transferase (GST), RANTES, tissue inhibitor of matrix metalloproteinase-1 (TIMP-1), plasminogen activator inhibitor-1 (PAI-1), thyroxine, and cortisol.

4. The method of claim 3, wherein said parameters are selected from the group consisting of BDNF, A2M, IL-10, IL-13, IL-18, thyroxine, and cortisol.

5. The method of claim 3, wherein said parameters are IL-7, A2M, IL-10, and IL-13.

6. The method of claim 3, wherein said parameters are IL-7, IL-13, A2M, BDNF, and IL-18.

7. The method of claim 3, wherein said parameters are IL-7, IL-10, IL-13, IL-15, A2M, GST, and IL-18.

8. The method of claim 3, wherein said parameters are IL-10, IL-13, IL-15, A2M, BDNF, thyroxine, cortisol, and IL-18.

9. The method of claim 3, wherein said parameters are IL-7, IL-13, IL-10, IL-15, IL-18, A2M, GST, and cortisol.

10. The method of claim 3, wherein said parameters are IL-7, IL-10, IL-13, IL-15, IL-18, A2M, GST, cortisol, and thyroxine.

11. The method of claim 1, wherein said parameters are selected from the group consisting of adrenocorticotropic hormone (ACTH), BDNF, cortisol, dopamine (DA), IL-1, IL-13, IL-18, norepinephrine, thyroid-stimulating hormone (TSH), arginine vasopressin (AVP), and corticotropin-releasing hormone (CRH).

12. The method of claim 11, wherein said parameters are selected from the group consisting of cortisol, ACTH, IL-1, IL-18, BDNF, DA, leptin, TSH, CRH, and AVP.

13. The method of claim 11, wherein said parameters are cortisol, ACTH, IL-1, IL-18, BDNF, leptin, TSH, CRH, and AVP.

14. The method of claim 11, wherein said parameters are cortisol, ACTH, IL-1, IL-18, BDNF, TSH, CRH, and AVP.

15. The method of claim 11, wherein said parameters are cortisol, ACTH, IL-1, IL-18, BDNF, TSH, and AVP.

16. The method of claim 11, wherein said parameters are cortisol, ACTH, IL-1, IL-18, BDNF, and TSH.

17. The method of claim 11, wherein said parameters are cortisol, ACTH, IL-1, IL-18, and BDNF.

18. The method of claim 11, wherein said parameters further comprise neuropeptide Y (NPY).

19. The method of claim 11, wherein said parameters further comprise platelet associated serotonin.

20. The method of claim 11, wherein said parameters further comprise one or more biomarkers selected from the group consisting of IL-7, IL-10, IL-15, FABP, A1AT, B2M, factor VII, EGF, A2M, GST, RANTES, PAI-1, and TIMP-1.

21. The method of claim 1, wherein said numerical values are biomarker levels in a biological sample from said subject.

22. The method of claim 21, wherein said biological sample is whole blood.

23. The method of claim 21, wherein said biological sample is serum.

24. The method of claim 21, wherein said biological sample is plasma.

25. The method of claim 21, wherein said biological sample is urine.

26. The method of claim 21, wherein said biological sample is cerebrospinal fluid.

27. The method of claim 1, wherein said subject is a human.

28. The method of claim 1, wherein said predetermined threshold is statistical significance.

29. The method of claim 28, wherein said statistical significance is p<0.05.

30. The method of claim 1, further comprising providing a numerical value for one or more parameters selected from the group consisting of magnetic resonance imaging, magnetic resonance spectroscopy, body mass index, measures of HPA activation, measures of thyroid function, measures of estrogen levels, or measures of testosterone levels.

31. The method of claim 1, further comprising providing a biological sample from said subject.

32. The method of claim 1, further comprising measuring said plurality of parameters to obtain said numerical values.

33. A method for monitoring treatment for major depressive disorder (MDD), comprising:
(a) providing numerical values for a plurality of parameters in a subject diagnosed as having MDD, said parameters being predetermined to be relevant to MDD;
(b) using an algorithm comprising said numerical values to calculate an MDD score;
(c) repeating steps (a) and (b) after a period of time during which said subject receives treatment for MDD, to obtain a post-treatment MDD score;
(d) comparing the post-treatment MDD score from step (c) to the score in step (b) and to a MDD score for normal subjects, and classifying said treatment as being effective if the score from step (c) is closer than the score from step (b) to the MDD score for normal subjects.

34. The method of claim 33, wherein step (b) comprises individually weighting each of said numerical values by a predetermined function, each function being specific to each parameter, and calculating the sum of the weighted values.

35. The method of claim 33, wherein said parameters are selected from the group consisting of BDNF, IL-7, IL-10, IL-13, IL-15, IL-18, FABP, A1AT, B2M, factor VII, EGF, A2M, GST, RANTES, TIMP-1, PAI-1, thyroxine, cortisol, and ACTH.

36. The method of claim 33, wherein said period of time ranges from weeks to months after the onset of said treatment.

37. The process of claim 33, wherein a subset of said numerical values are provided for time points prior to and after initiation of said treatment.

38. The method of claim 33, wherein said parameters comprise measurements derived from magnetic resonance imaging, magnetic resonance spectroscopy, or computerized tomography scans.

39. The method of claim 33, wherein said parameters comprise body mass index.

40. The method of claim 33, wherein said parameters comprise NPY.

41. The method of claim 33, wherein said parameters comprise AVP.

42. The method of claim 33, wherein said parameters comprise a catecholamine or a urinary metabolite of a catecholamine.

43. The method of claim 33, wherein said numerical values are biomarker levels in a biological sample from said subject.

44. The method of claim 43, wherein said biological sample is serum.

45. The method of claim 43, wherein said biological sample is plasma.

46. The method of claim 43, wherein said biological sample is urine.

47. The method of claim 43, wherein said biological sample is cerebrospinal fluid.

48. The method of claim 33, further comprising providing a biological sample from said subject.

49. The method of claim 33, further comprising measuring the levels of said plurality of parameters to obtain said numerical values.

50. A computer-implemented method for diagnosing major depressive disorder (MDD), comprising:
providing a biomarker library database that includes selected biomarker parameters that are predetermined to be relevant to MDD, sets of combinations of the biomarkers and coefficients the sets of combinations based on clinical data obtained from patients with MDD; and
using a computer processor to apply a set of combination of the biomarkers and associated coefficients to measured values of the biomarker in the set obtained from a patient based on a predetermined algorithm to produce an MDD score for diagnosing whether the patient has MDD.
